(19) United States
(12) Patent Application Publication
(10) Pub. No.: US 2010/0294797 A1
(43) Pub. Date: Nov. 25, 2010

(54) BEVERAGE MACHINES, SUBSYSTEMS THEREOF AND CORRESPONDING METHODS

(76) Inventor: Shlomo Hirschbain, Jerusalem (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/738,636

(22) PCT Filed: Oct. 22, 2008
(86) PCT No.: PCT/IL08/01367

§ 371 Date: Apr. 18, 2010

(30) Foreign Application Priority Data
Oct. 18, 2007 (IL) 186784

(51) Int. Cl. B67D 7/00; H05B 1/02; B67D 7/82

(52) U.S. Cl. 222/1; 219/494; 222/146.5

(57) ABSTRACT

A mix-in-the-cup automated beverage dispensing machine includes a powder dispensing system with a rotary support structure bringing each powder container to a common dispensing location in turn. The machine also provides a water heater with a thermal conduction block and a method for heating water based on pre-calculation of the required heating profile. Also provided is a fresh milk dispensing system which maintains a fully cooled flow path from the container to the cup while ensuring that all components contacting the milk are disposable single-use components. Additional features discussed relate to a mixer unit cleaned by spinning within the cup, a structurally simple cup conveyance arrangement, and an cup elevator with geometrical locking.

### FIELD AND BACKGROUND OF THE INVENTION

The present invention relates to beverage machines and, in particular, it concerns subsystems of a beverage machine useful for storing and dispensing powders, heating and dispensing water, storing and dispensing milk, stirring in a cup and delivering a cup to a user.

While believed to be particularly advantageous when used together in synergy, the various aspects of the present invention are also of separate utility and will be best understood when described in the context of the relevant background. For this reason, both the background and the description will be subdivided according to the separate aspects of the invention.

### Storing and Dispensing Powders

Many automated beverage machines employ powders which are dispensed and mixed with hot or cold water, or some other liquid, to produce the desired beverage. Typically, a plurality of different types of powder are stored within the machine for making a variety of drinks. The powder containers are typically arranged in side-by-side alignment across the width of the machine. In order to accommodate the required number of containers each with sufficient volume, beverage machines are often relatively wide. The side-by-side arrangement also requires a plurality of water/powder mixers and tubing to bring water to each of the mixers and to bring the mixed drink component to the cup. Alternatively, for mix-in-the-cup machines, a linear conveyor of significant length is typically required to bring the cup to each of the powder dispensing positions.

U.K. Patent No. 817188 discloses a dispensing machine which includes a “commodity wheel” with a plurality' of compartments rotating about a horizontal axle. It appears that the storage capacity of this arrangement is very limited.

### Heating and Dispensing Water

Water heating systems for beverage machines typically either heat water on-demand or maintain a pre-heated tank of hot water. The heat-on-demand approach theoretically provides numerous advantages. Firstly, heat-on-demand avoids the energy loss inherent to maintaining a tank of water at elevated temperature for extended periods. Secondly, a heat-on-demand system typically heats the water while the water flows through the system, thereby largely avoiding problems of scale deposition from hard water. Additionally, a heat-on-demand device may be much more compact than a system based on a storage tank.

In practice, heat-on-demand devices are not often used for a number of reasons. Firstly, the power required to heat a flow of water from room temperature to near boiling is often prohibitive. For example, to heat a flow of 25 cc per second from 20° C. to 90° C. requires a power supply of more than 7 kW. This would limit use of the device to locations provided with special power supply installations, and is not suitable for a general purpose beverage machine. Additionally, any non-uniformity of the heating effect could be potentially hazardous if a local hot-spot generates enough heat to cause local boiling of the water and corresponding pressure build-up.

For these and other reasons, the predominant choice for beverage machines is the use of a hot water storage tank which maintains a significant volume of water at the desired temperature. This takes significant space, is wasteful of energy, and tends to suffer from scale deposition.

### Storing and Dispensing Milk

Many hot beverages are normally served with milk as a primary ingredient or as an optional additive. However, provision of milk in an automated beverage machine presents a number of problems.

Firstly, although the shelf life of fresh pasteurized milk under refrigeration is sufficiently long to last between machine servicing every two or three days, any drop of milk which is not refrigerated will quickly spoil and turn sour. Furthermore, any contact between such a drop of soured milk and the remaining refrigerated milk rapidly accelerates bacterial growth in the main body of the milk leading to all the milk spoiling rapidly. Use of such spoiled milk in dispensed drinks would render the drinks unpalatable and could be potentially dangerous.

A further problem in implementing a fresh milk dispensing system is that thorough cleaning is needed of all parts coming in contact with the milk every time the milk supply is replenished. This is labor intensive, and may not be feasible in general purpose beverage machines where on-site servicing must be maintained to a minimum.

For these reasons, automated beverage machines typically employ only dried powdered milk, with a consequent reduction in the quality of the resulting drinks.

### Stirring in a Cup

As an alternative to complicated arrangements of tubing and multiple mixer assemblies, certain automated beverage dispensers employ a mix-in-the-cup approach in which water or other liquids are added to various powders in the cup to be dispensed and mixing occurs within the cup itself. To effect mixing, a rotary stirrer or agitator is typically lowered into the cup and turned rapidly. An example of such a system may be found in U.S. Pat. No. 5,625,198.

A concern for commercial implementation of mix-in-the-cup machines is the cleanliness of the mixer. For each drink dispensed, the mixer is immersed in the cup, often with mixtures including sugar, milk powder and other excellent supporters of bacterial growth. If the stirrer is not properly cleaned or dried between operations, there is a concern that the mixer could become a source of contamination for the system.

### Delivering a Cup to a User

Finally, automated beverage machines provided in various locations require considerable resistance to vandalism. For machines which dispense cups, a sizeable opening is necessarily required, thereby leaving the machine susceptible to attempts to reach inside through the opening or obstruct the opening.

### SUMMARY OF THE INVENTION

The present invention relates to a beverage machine, various subsystems thereof, and various methods implemented therein.

According to the teachings of the present invention there is provided, a method for delivering portions of hot liquid on demand comprising the steps of: (a) providing a heating arrangement including: (i) a thermal conduction block, and (ii) at least one passageway through the block at least partially defining an elongated flow path from a heating arrangement inlet to a heating arrangement outlet, the elongated flow path having a volume V₀; (b) preheating the thermal conduction block together with the liquid in the elongated flow path to a raised temperature T₀; (c) receiving a request for dispensing a volume V of liquid at a temperature T; (d) calculating a dispensing program including actuation of a heating element to supply heat energy to the liquid in coordination with allowing liquid flow through the elongated flow path, calculation of the dispensing program being based at least in part on parameters V, T, V₀, T₀ and an input temperature of the liquid; and (e) dispensing the portion of liquid through the outlet by actuating the heating element and allowing liquid flow through the elongated flow path according to the dispensing program.

According to a further feature of the present invention, the dispensing program is adjusted during the dispensing of the liquid based upon measurement of a rate of liquid flow through the heating arrangement.

According to a further feature of the present invention, the input temperature of the liquid is measured by a temperature sensor.

According to a further feature of the present invention, the dispensing program is adjusted based upon measurement of the input temperature of the liquid supplied to the inlet as measured during the dispensing.

According to a further feature of the present invention, the calculation of the dispensing program and the dispensing are calculated and dispensed, respectively, with supply of heat energy by the heating element to the thermal conduction block.

According to a further feature of the present invention, the dispensing program is implemented such that: (a) during a first period, a temperature of the thermal conduction block is adjusted from temperature T₀ to within a given margin of the required temperature T; and (b) during a second period, the heating element is actuated as a function of a rate of flow of liquid through the elongated passageway to minimize temperature variations in the thermal conduction block while the liquid flows through the elongated passageway.

According to a further feature of the present invention, adjusting the temperature of the thermal conduction block is performed by actuating the heating element prior to allowing flow of liquid through the elongated passageway.

According to a further feature of the present invention, adjusting the temperature of the thermal conduction block is performed by allowing flow of liquid through the elongated passageway without actuating the heating element.

According to a further feature of the present invention, steps (c), (d) and (e) are repeated to dispense a plurality of portions of heated liquid, and wherein step (d) is performed each time using a new value of T₀ measured prior to the calculating.

According to a further feature of the present invention, the plurality of requests define a plurality of differing respective temperatures T for the portions of liquid requested.

According to a further feature of the present invention, the differing temperatures span a range of at least about 15 degrees Celsius, and wherein the preheating is performed to maintain the thermal conduction block at a standby temperature within about 10 degrees below a lower end of the range when no request is received for a given period.

According to a further feature of the present invention, the plurality of requests define a plurality of differing respective volumes V for the portions of liquid requested.

According to a further feature of the present invention, the liquid is water, and wherein the method is performed by an automated beverage machine.

There is also provided according to the teachings of the present invention, a heater for delivering portions of hot liquid on demand comprising: (a) a heating arrangement including: (i) a thermal conduction block, (ii) at least one passageway through the block at least partially defining an elongated flow path from a heating arrangement inlet to a heating arrangement outlet, the elongated flow path having a volume V₀, and (iii) a heating element deployed so as to deliver heat energy to the block; (b) a first temperature sensor deployed to indicate a temperature of liquid within the elongated passageway; (c) a valve deployed to selectively allow flow of liquid through the heating arrangement; and (d) a controller including at least one processor, the controller being connected to receive signals from at least the first temperature sensor and to selectively actuate the valve and the heating element, wherein the controller is configured to: (i) actuate the heating element to ensure preheating of the thermal conduction block together with the liquid in the elongated flow path to a raised temperature T₀; (ii) receive a request for dispensing a volume V of liquid at a temperature T; (iii) calculate a dispensing program including actuation of the heating element to supply heat energy to the liquid in coordination with allowing liquid flow through the elongated flow path, calculation of the dispensing program being based at least in part on parameters V, T, V₀, T₀ and an input temperature of the liquid; and (iv) dispense the portion of liquid through the outlet by actuating the heating element and the valve according to the dispensing program.

According to a further feature of the present invention, there is also provided a second temperature sensor deployed to indicate a temperature of liquid supplied to the inlet, thereby providing to the controller the input temperature of the liquid.

According to a further feature of the present invention, the controller is further configured to vary the dispensing program during flow of the liquid based upon the signal from the second temperature sensor.

According to a further feature of the present invention, there is also provided a flow sensor deployed to measure a rate of liquid flow through the elongated passageway.

According to a further feature of the present invention, the controller is further configured to vary the dispensing program during flow of the liquid based upon the signal from the flow sensor.

According to a further feature of the present invention, the controller is further configured to: (a) during a first period, adjust a temperature of the thermal conduction block from an initial temperature to within a given margin of the required temperature T; and (b) during a second period, actuate the heating element as a function of a rate of flow of liquid through the elongated passageway to minimize temperature variations in the thermal conduction block while the liquid flows through the elongated passageway.

According to a further feature of the present invention, the controller actuates the heating element prior to opening the valve so as to adjust the temperature of the thermal conduction block upwards.

According to a further feature of the present invention, the controller opens the valve prior to actuating the heating element so as to adjust the temperature of the thermal conduction block downwards.

According to a further feature of the present invention, the heating arrangement together with the quantity of the liquid contained within the elongated passageway has a total heat capacity not exceeding 1 kJ/K, and wherein a majority of the heat capacity is in the block.

According to a further feature of the present invention, the thermal conduction block is implemented as a block of substantially constant cross-sectional form, and wherein a pair of end covers define connecting passageways between portions of the elongated flow path.

According to a further feature of the present invention, there is also provided a scale reduction arrangement including a magnetic scale inhibitor and a circulator arrangement deployed to selectively circulate liquid through the elongated passageway and the magnetic scale inhibitor.

There is also provided according to the teachings of the present invention, a heater for heating a liquid, the heater comprising: (a) a thermal conduction block having an extensional direction, the thermal conduction block being formed from a metallic material; (b) a plurality of though-bores extending through the thermal conduction block parallel to the extensional direction from a first end surface to a second end surface; (c) a first cover in sealing engagement with the first end surface and configured to define connecting passageways between pairs of the through-bores; (d) a second cover in sealing engagement with the second end surface and configured to define connecting passageways between pairs of the through-bores; and (e) a heating element associated with the thermal conduction block, wherein a cross-sectional form of the thermal conduction block taken perpendicular to the extensional direction is substantially invariant along a length of the thermal conduction block, and wherein the first and second covers are configured to define an elongated flow path extending from a fluid inlet formed in one of the covers through a plurality of the through-bores to a fluid outlet formed in one of the covers.

According to a further feature of the present invention, the heating element is deployed within an additional through-bore formed through the thermal conduction block and extending parallel to the extensional direction.

According to a further feature of the present invention, there is also provided a flow meter deployed within one of the first and second covers to measure a rate of flow of liquid through the elongated flow path.

According to a further feature of the present invention, there is also provided a valve deployed within one of the first and second covers to control flow of liquid through the elongated flow path.

According to a further feature of the present invention, there is also provided a scale reduction arrangement including: (a) a magnetic scale-inhibitor; and (b) a circulator arrangement including a pump, the circulator arrangement being associated with one of the first and second covers and forming a flow path connecting between two points along the elongated flow path and passing through the magnetic scale-inhibitor.

There is also provided according to the teachings of the present invention, a heater for heating a liquid, the heater comprising: (a) a liquid heating arrangement having a primary flow path extending from an inlet to an outlet; (b) a magnetic scale-inhibitor; (c) a circulator arrangement including a pump, the circulator arrangement forming a secondary flow path connecting between two points along the primary flow path and passing through the magnetic scale-inhibitor; and (d) a controller associated with the pump, the controller being configured to intermittently actuate the pump to circulate liquid in The primary flow path through the magnetic scale-inhibitor.

According to a further feature of the present invention, the controller is associated with a flow control arrangement deployed to control flow of liquid passing through the outlet, and wherein the controller is configured to actuate the pump selectively during periods when no flow is passing through the outlet.

There is also provided according to the teachings of the present invention, a milk delivery system for storing and delivering milk from a container of milk to a cup, the milk delivery system comprising: (a) a housing having an enclosed volume for receiving the container of milk; (b) a cooling conduit deployed to define a flow path from the enclosed volume of the housing to a point of delivery to the cup, the cooling conduit being formed from a thermally conductive material; (c) a cooling arrangement deployed to cool the enclosed volume and the cooling conduit; (d) a length of flexible tubing removably insertable through the cooling conduit so as to form a sealed flow path from the container of milk to the point of delivery to the cup; and (e) a peristaltic pump deployed to receive a part of the flexible tubing and configured for pumping milk from the container of milk along the flexible tubing to the point of delivery to the cup.

According to a further feature of the present invention, the length of flexible tubing is formed with a dispensing nozzle configured to engage an end portion of the cooling conduit, thereby defining a fully inserted state of the flexible tubing.

According to a further feature of the present invention, the cooling arrangement is deployed to cool the enclosed volume, and wherein the cooling conduit is cooled via thermal coupling with the enclosed volume.

According to a further feature of the present invention, the peristaltic pump is deployed within the enclosed volume.

According to a further feature of the present invention, the housing is configured to receive two containers of milk, and wherein the cooling conduit is part of a conduit arrangement defining two flow paths from the enclosed volume of the housing to a point of delivery to the cup, and wherein the length of flexible tubing is one of two lengths of flexible tubing removably insertable through the cooling conduit so as to each form a sealed flow path from one of the containers of milk to the point of delivery to the cup.

According to a further feature of the present invention, both of the lengths of flexible tubing have parts received within the peristaltic pump, the milk delivery system further including a flow switching arrangement deployed upstream of the peristaltic pump and configured to selectively prevent flow in one or other of the lengths of flexible tubing.

According to a further feature of the present invention, there is also provided an optical sensing arrangement associated with each of the lengths of flexible tubing and configured to generate a signal indicative of the presence or absence of milk within each of the lengths of flexible tubing, wherein the flow switching arrangement is configured to switch between the two lengths of flexible tubing in response to signals from the optical sensing arrangement.

There is also provided according to the teachings of the present invention, an automated beverage dispensing machine comprising: (a) the aforementioned milk delivery system; (b) a powder dispensing system; and (c) a hot water dispensing system, the milk delivery system, the powder dispensing system and the hot water dispensing system being configured to cooperate to dispense a hot beverage in a cup.

There is also provided according to the teachings of the present invention, a powder dispenser for a beverage machine, the powder dispenser comprising: (a) a plurality of powder containers each having an opening for refilling the powder container and an auger dispensing mechanism for dispensing powder from the container via an outlet; and (b) a rotary support mechanism supporting the plurality of powder containers, the rotary support mechanism being rotatable about a substantially vertical axis, wherein the powder containers are deployed such that, for each powder container, a corresponding position of the rotary support mechanism brings the outlet of the powder container to a common dispensing location.

According to a further feature of the present invention, each of the containers is formed with a pair of non-parallel walls such that, when deployed on the rotary support mechanism, the pair of walls extend substantially radially relative to the vertical axis.

According to a further feature of the present invention, each of the containers has a horizontal cross-sectional shape corresponding substantially to a sector of a circle.

According to a further feature of the present invention, the plurality of containers, when deployed on the rotary support mechanism, form an overall external form corresponding substantially to a cylinder.

According to a further feature of the present invention, each outlet is located at a region of the corresponding powder container proximal to the vertical axis.

According to a further feature of the present invention, there is also provided a drive arrangement including an electric motor, the drive arrangement being configured to selectively engage the auger dispensing mechanism of each of the powder containers when the corresponding container is located with its outlet at the common dispensing location.

According to a further feature of the present invention, the drive arrangement includes a rotary drive linkage, at least part of the rotary drive linkage being formed from a helical spring deployed to accommodate variations in alignment between the drive arrangement and the auger dispensing mechanism.

According to a further feature of the present invention, the drive arrangement includes a drive linkage displacement arrangement for selectively displacing at least part of the drive arrangement so as to selectively engage and release driving connection between the drive arrangement and the one of the auger dispensing mechanisms with which the drive arrangement is aligned.

There is also provided according to the teachings of the present invention, an automated beverage dispensing machine for providing a user with a drink in a cup, the automated dispensing machine comprising: (a) a cup dispensing subsystem for dispensing a cup; (b) a powder dispensing subsystem for dispensing powder to a powder dispensing location; (c) a water dispensing subsystem for dispensing water to a water dispensing location; and (d) a cup conveyance arrangement configured for receiving a cup from the cup dispensing subsystem and conveying the cup to the powder dispensing location and the water dispensing location, and subsequently providing the cup to the user, the cup conveyance arrangement including: (i) a cup supporting arm mounted so as to be pivotally movable about a vertical axis, and (ii) a cup delivery elevator having a vertically displaceable platform for delivering the cup along a vertical path of motion to the user, wherein the powder dispensing location, the water dispensing location and a lifting location on the vertical path of motion are all located on an arc centered at the vertical axis such that pivotal motion of the cup supporting arm is sufficient to bring the cup to each of the locations.

According to a further feature of the present invention, the cup supporting arm has a rigid cup-gripping configuration configured such that, when the cup supporting arm brings a cup to the lifting location, partial raising of the cup delivery elevator is effective to disengage the cup from the cup-gripping configuration and to allow pivotal motion of the cup supporting arm to move clear of the cup delivery elevator.

According to a further feature of the present invention, the powder dispensing subsystem includes a plurality of powder containers each having a powder dispensing outlet, and a conveyor arrangement for displacing the powder containers to sequentially bring each of the powder dispensing outlets to the powder dispensing location.

According to a further feature of the present invention, there is also provided a mixer having a vertically displaceable stirrer for stirring the contents of the cup at a stirring location, wherein the stirring location is located on the arc.

There is also provided according to the teachings of the present invention, a method for operating a mix-in-the-cup beverage machine comprising the steps of: (a) providing a mix-in-the-cup station including: (i) a cup holder for holding a cup containing powder in a given position, (ii) a water supply arrangement for delivering water into the cup, and (iii) a mixer including a stirrer on a rotatable shaft which is axially displaceable downwards into the cup; (b) positioning a cup containing powder in the cup holder; (c) adding to the cup a quantity of water; (d) lowering the stirrer into the water and spinning the stirrer so as to mix the contents of the cup; (e) raising the stirrer to a position above the surface of the mixed contents but enclosed by the walls of the cup; (f) spinning the stirrer so as to substantially dry the stirrer; and (g) raising the stirrer out of the cup.

According to a further feature of the present invention, the adding adds a first quantity of water to the cup, and further comprising adding a second quantity of water to the cup after raising the stirrer out of the cup.

There is also provided according to the teachings of the present invention, an automated beverage dispensing machine comprising a cup delivery arrangement including: (a) a platform for supporting a cup; (b) a vertical linear bearing arrangement associated with the platform and defining a vertical path of motion of the platform; and (c) a drive arrangement including an actuator for moving a mechanical linkage so as to displace the platform along the vertical path of motion from a lowered position to a raised dispensing position, wherein the mechanical linkage is configured such that, in the raised dispensing position of the platform, the mechanical linkage assumes a geometrically locked state to oppose downward force applied to the platform.

According to a further feature of the present invention, wherein actuator displaces a first arm through a pivotal motion, and wherein the mechanical linkage includes a second arm pivotally connected to the first arm and to the platform, the first and second arms providing over-center locking in the locked state.

### BRIEF DESCRIPTION OF THE DRAWINGS

The invention is herein described, by way of example only, with reference to the accompanying drawings, wherein:

FIG. 1A is an isometric view of an automated beverage dispensing system, constructed and operative according to the teachings of the present invention, shown in a closed state;

FIG. 1B is an isometric view of the automated beverage dispensing system of FIG. 1A opened and partially cut-away to reveal the internal components;

FIG. 1C is a block diagram showing the main functional components of the automated beverage dispensing system of FIG. 1A;

FIG. 2 is a simplified flowchart for vending hot drinks, in accordance with an embodiment of the present invention;

FIG. 3A is an isometric view of a powder dispenser, constructed and operative according to an aspect of the present invention, suited for use in the automated beverage dispensing machine of FIG. 1A;

FIGS. 3B and 3C are cut-away isometric views taken through the powder dispensing system of FIG. 3A showing a drive arrangement in a disengaged state and in an engaged state, respectively;

FIG. 4 is a simplified flow chart of a method for controlling powder flow in the system of FIG. 1A, in accordance with an embodiment of the present invention;

FIG. 5A is a schematic isometric view of a water heater in accordance with an embodiment of the present invention;

FIG. 5B is a schematic isometric cut-away view of the water heater of FIG. 5A cut along a plane corresponding to line A-A in FIG. 5A;

FIG. 5C is a schematic isometric cut-away view of the water heater of FIG. 5A cut along a plane corresponding to line B-B in FIG. 5A;

FIGS. 5D and 5E are isometric and plan views, respectively, of a top cover of the water heater of FIG. 5A;

FIG. 5F is a two-plane cross-sectional view taken along the line designated A-A in FIG. 5E;

FIG. 6 is a flow chart of a method for heating and controlling the temperature of a liquid in dispensing a hot drink, in accordance with an embodiment of the present invention;

FIGS. 7A-7F are schematic graphs illustrating operation of the heater of FIG. 5A according to the method of FIG. 6 in various scenarios of initial heater temperature, requested temperature and various flow rate conditions;

FIG. 8 is a schematic cross-sectional view of a milk delivery system, constructed and operative according to the teachings of an aspect of the present invention;

FIG. 9 is an enlarged schematic plan view of a flow switching arrangement from the milk delivery system of FIG. 8;

FIGS. 10A and 10B are schematic isometric views of a peristaltic pump from the milk delivery system of FIG. 8 shown in an open state and a closed state, respectively;

FIGS. 10C and 10D are schematic end and side views, respectively, of the peristaltic pump of FIG. 10A;

FIG. 11A is a schematic isometric view of a mixer, constructed and operative according to the teachings of an aspect of the present invention;

FIG. 11B is a schematic cross-sectional view taken along the line A-A of FIG. 11A;

FIG. 11C is a schematic horizontal cross-sectional view taken along line B-B of FIG. 11A;

FIG. 12 is a flow chart illustrating a sequence of filling and mixing a drink in a cup according to an aspect of the present invention;

FIG. 13A is a schematic isometric view of a cup supporting arm forming part of a cup conveyance arrangement constructed and operative according to the teachings of an aspect of the present invention;

FIG. 13B is a plan view of the cup supporting arm of FIG. 13A showing its arcuate path of motion;

FIG. 14 is a flow chart of a cup handling method for implementing using the cup supporting arm of FIG. 13A according to the teachings of an aspect of the present invention;

FIGS. 15A and 15B are schematic isometric views of a cup elevator, constructed and operative according to the teachings of an aspect of the present invention, shown in a fully lowered state and a fully raised state, respectively;

FIGS. 15C and 15D are schematic side views corresponding to the states of FIGS. 15A and 15B, respectively;

FIG. 16A is a schematic isometric view of a cup storage and delivery apparatus, in accordance with an embodiment of the present invention;

FIGS. 16B and 16C are schematic isometric views of a cup release mechanism from the apparatus of FIG. 16A in two positions during release of a cup; and

FIG. 17 is a flow chart showing a sequence of operations performed by the apparatus of FIG. 16A during release of a cup.

### DESCRIPTION OF THE PREFERRED EMBODIMENTS

The present invention relates to a beverage machine, various subsystems thereof, and methods implemented therein.

The principles and operation of beverage machines, their subsystems and the corresponding methods according to the present invention may be better understood with reference to the drawings and the accompanying description.

By way of introduction, the beverage machine of the present invention includes a number of subsystems and implements a number of methods, each of which is believed to be patentable in its own right, but which are used to advantage in synergy according to a particularly preferred implementation of the present invention.

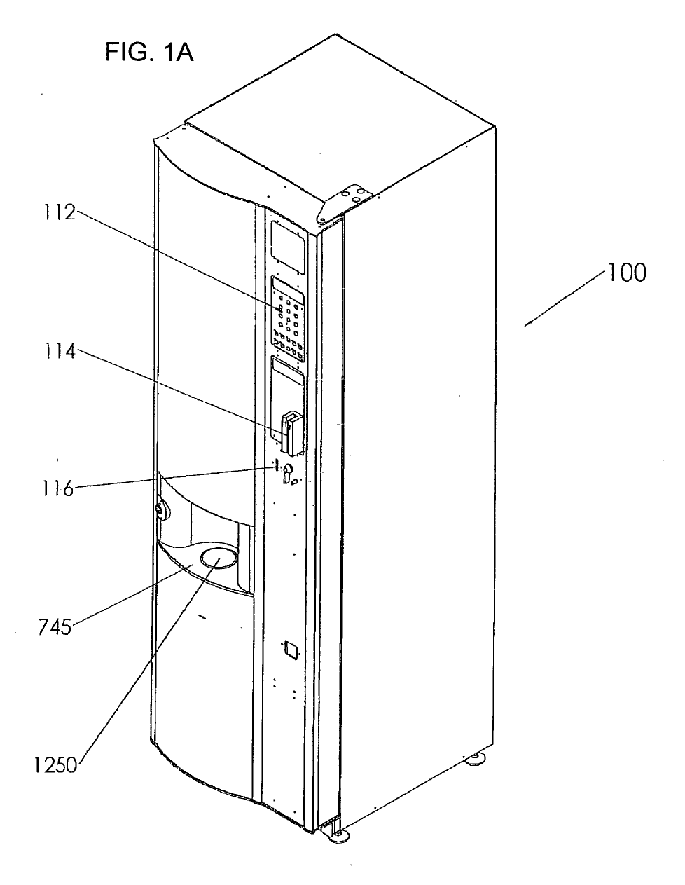

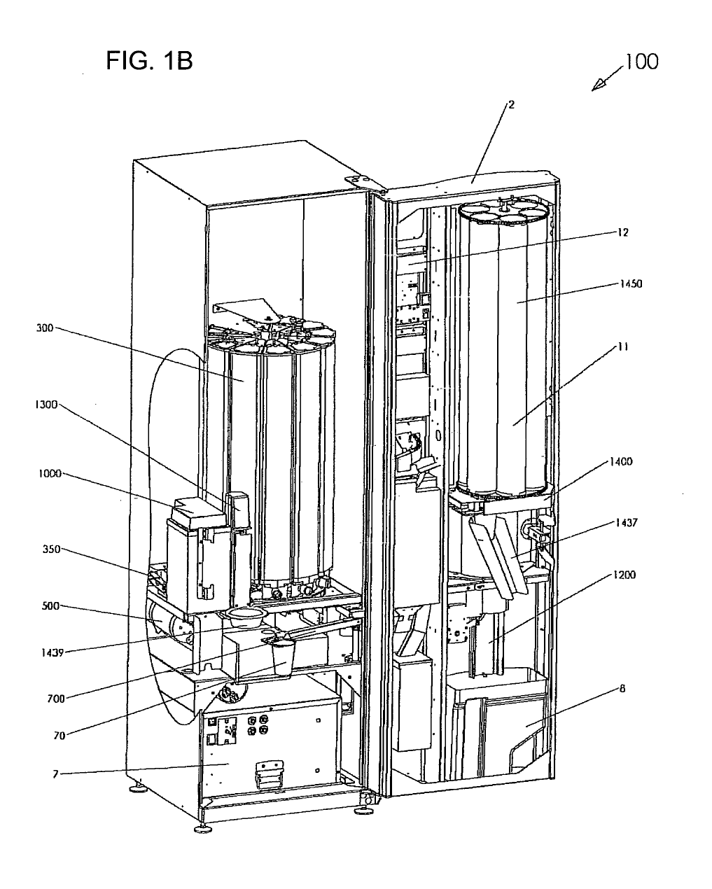

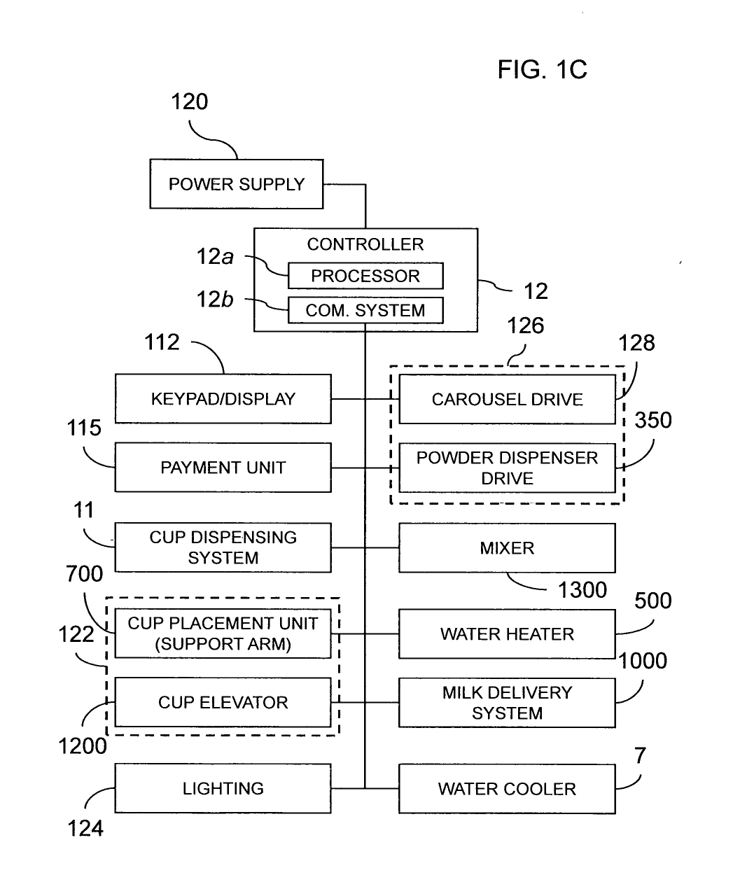

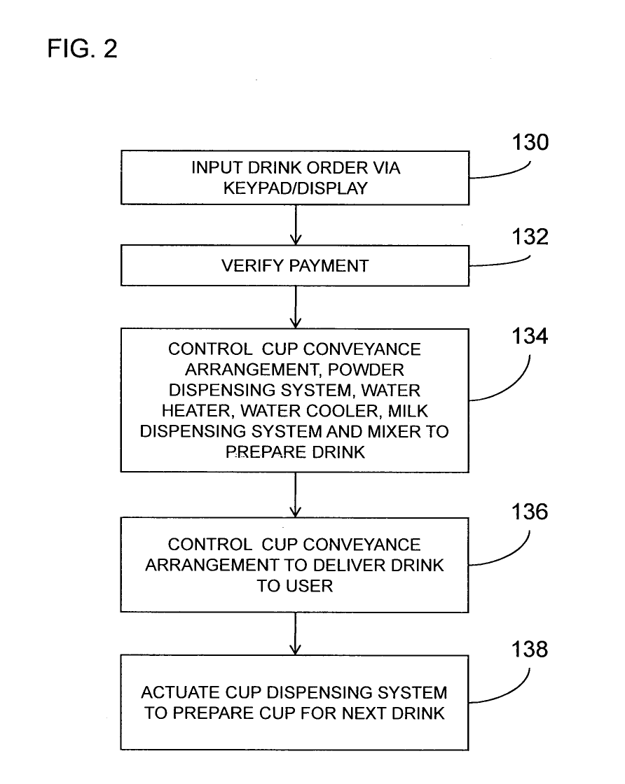

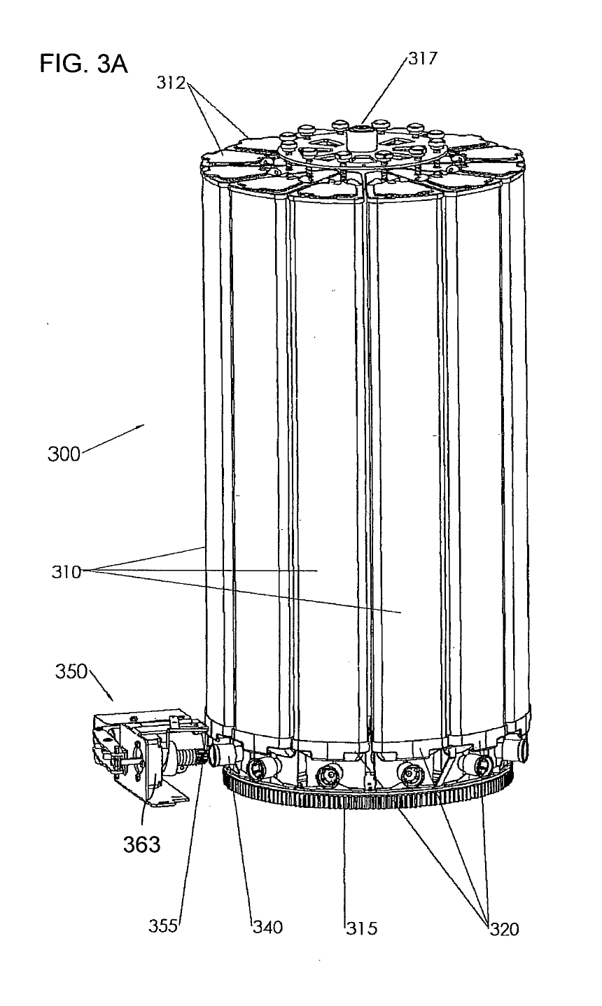

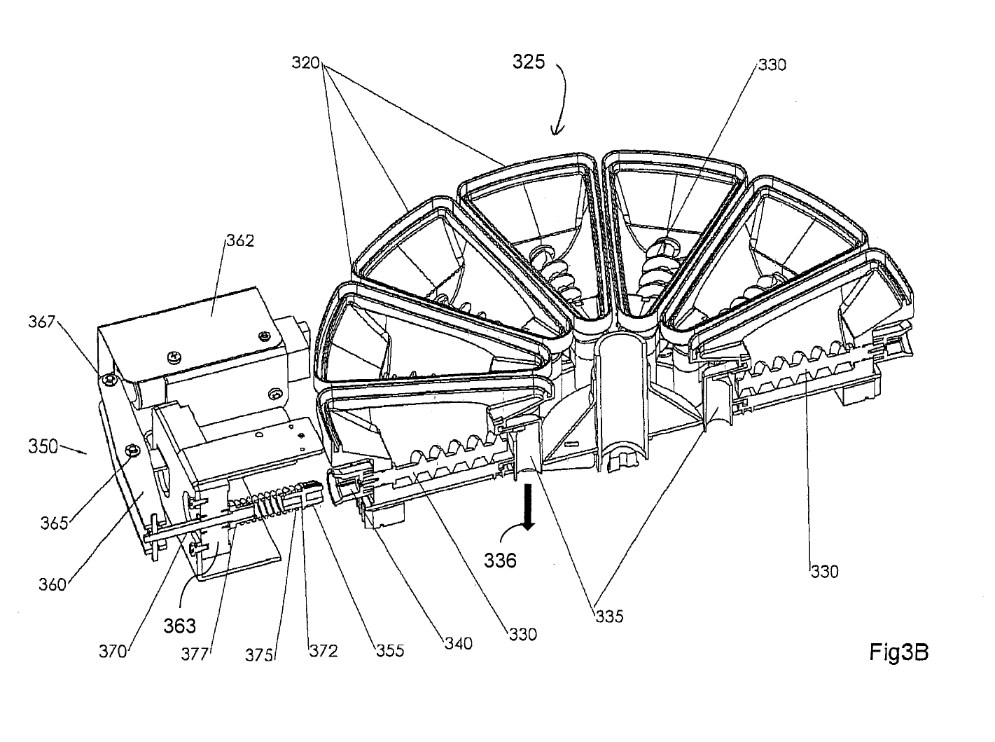

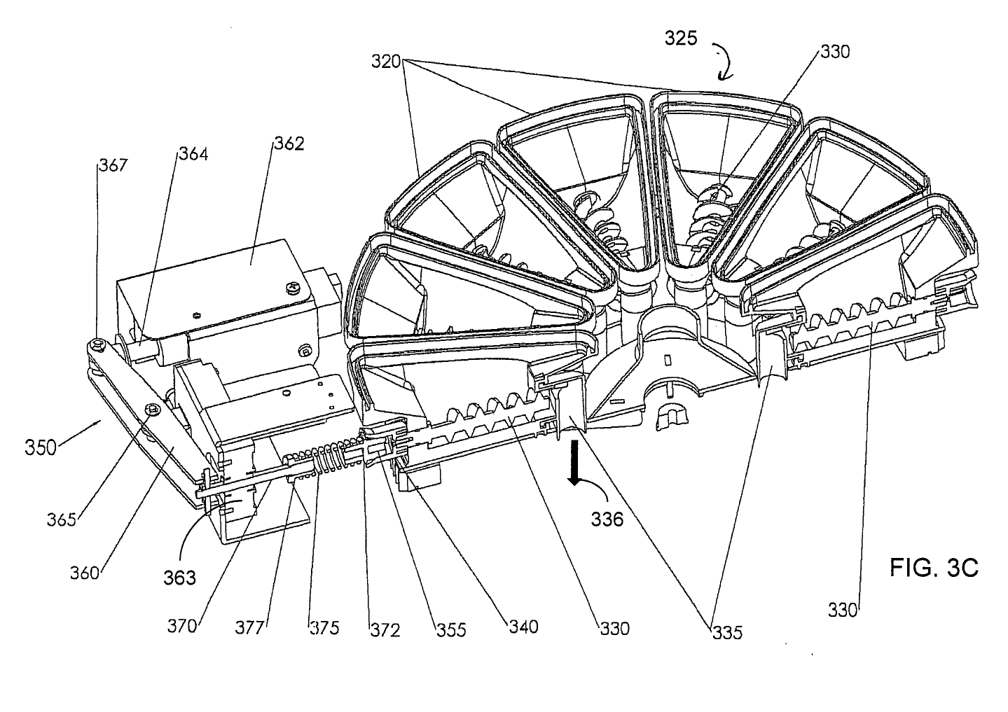

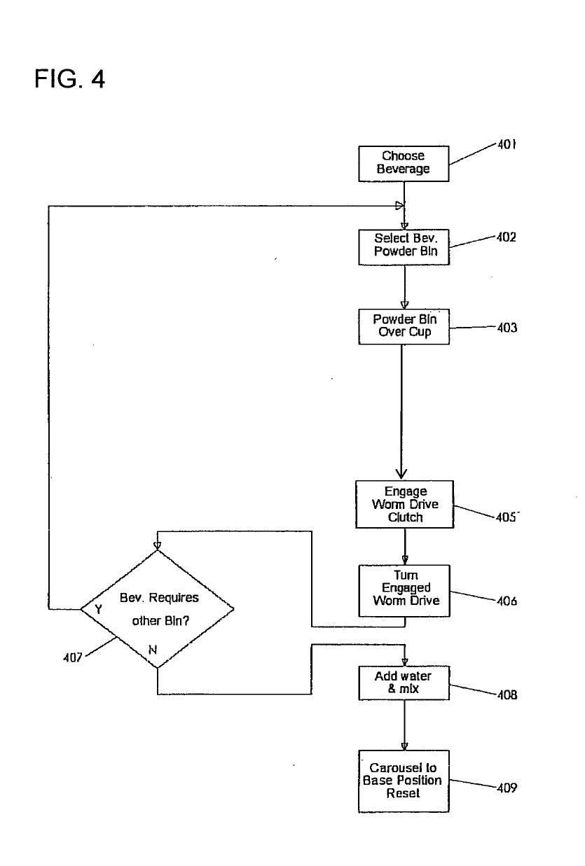

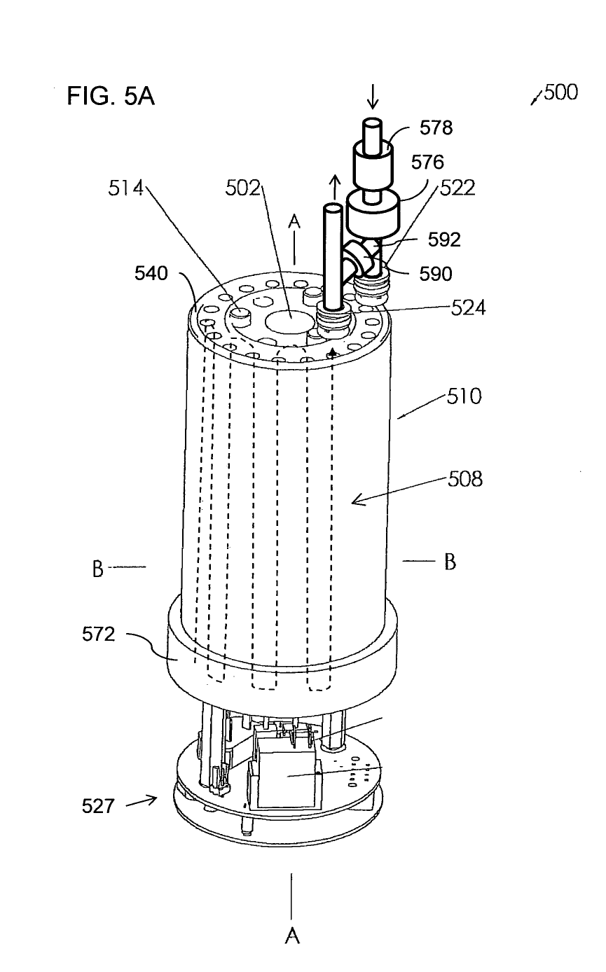

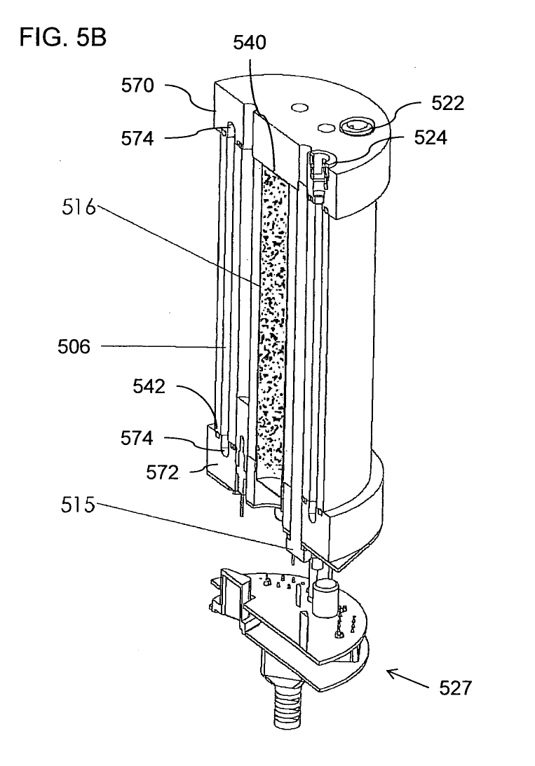

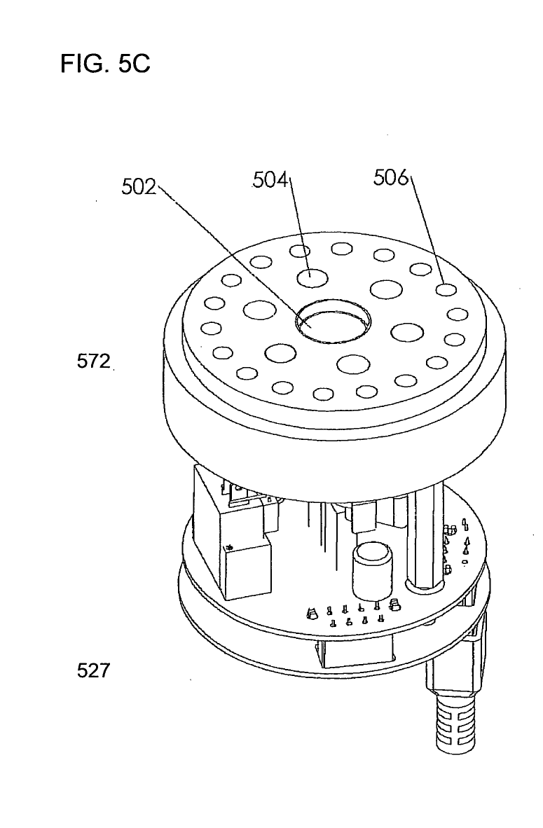

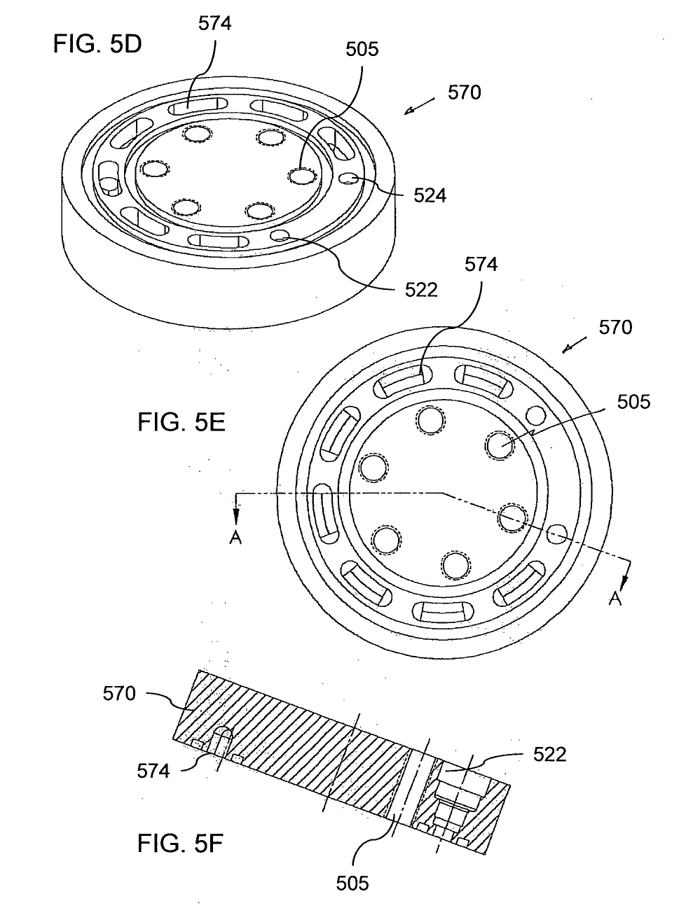

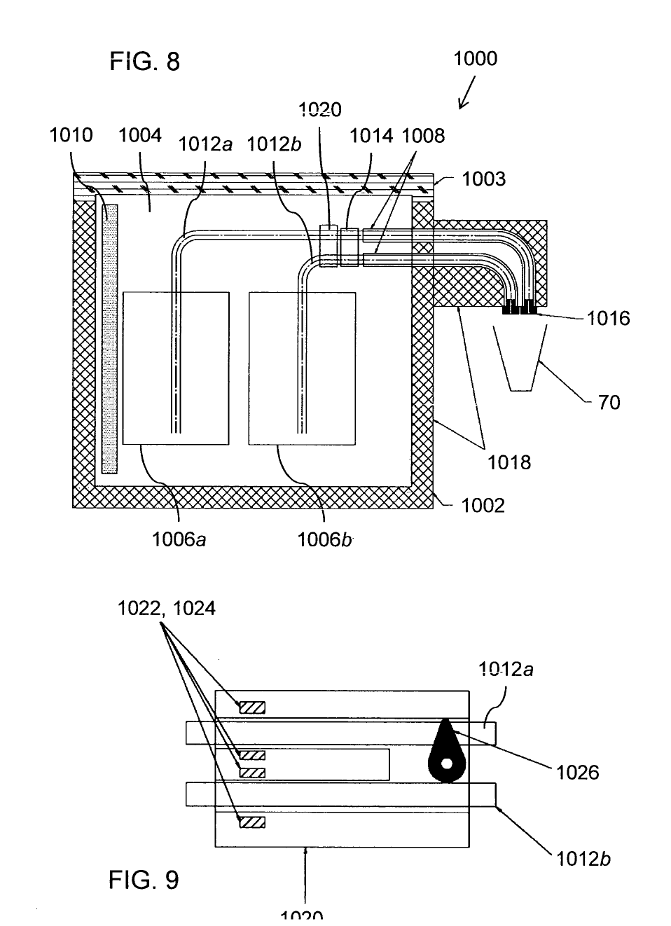

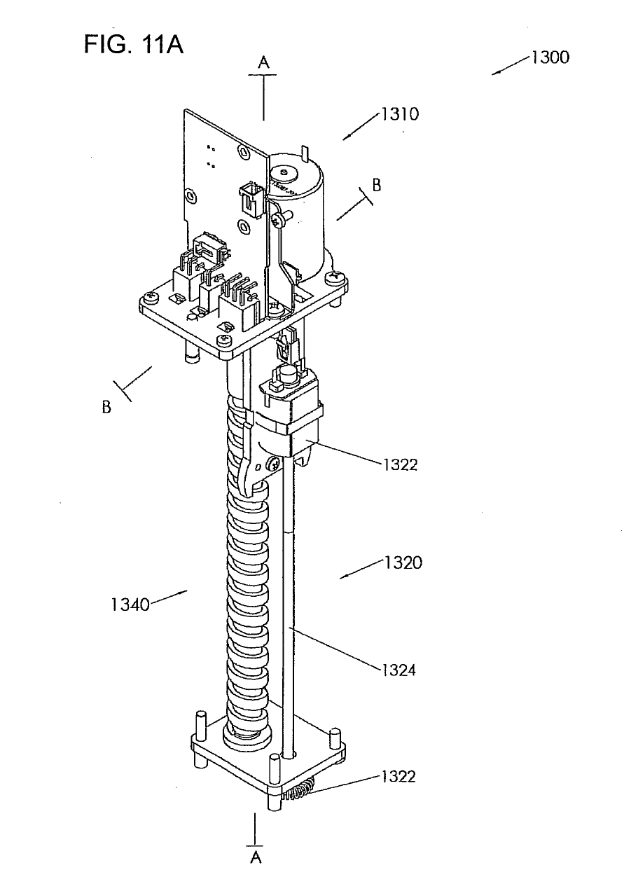

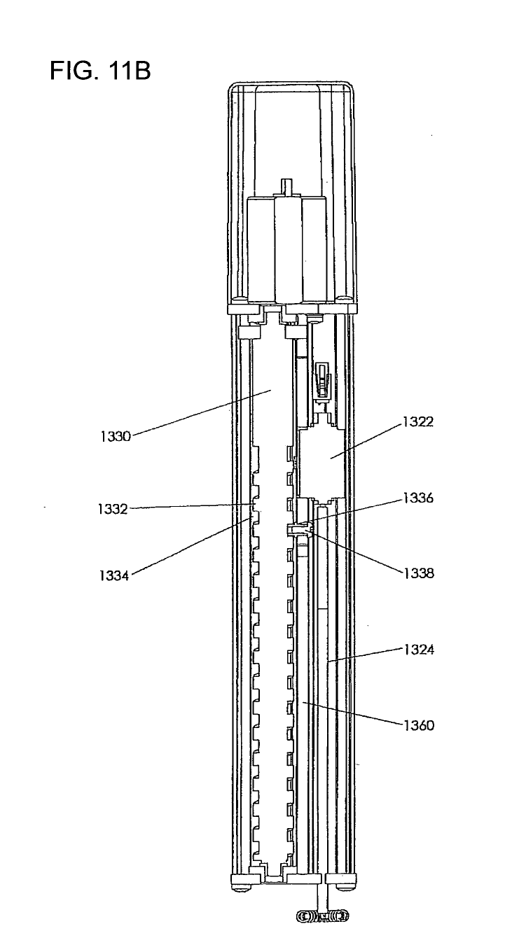

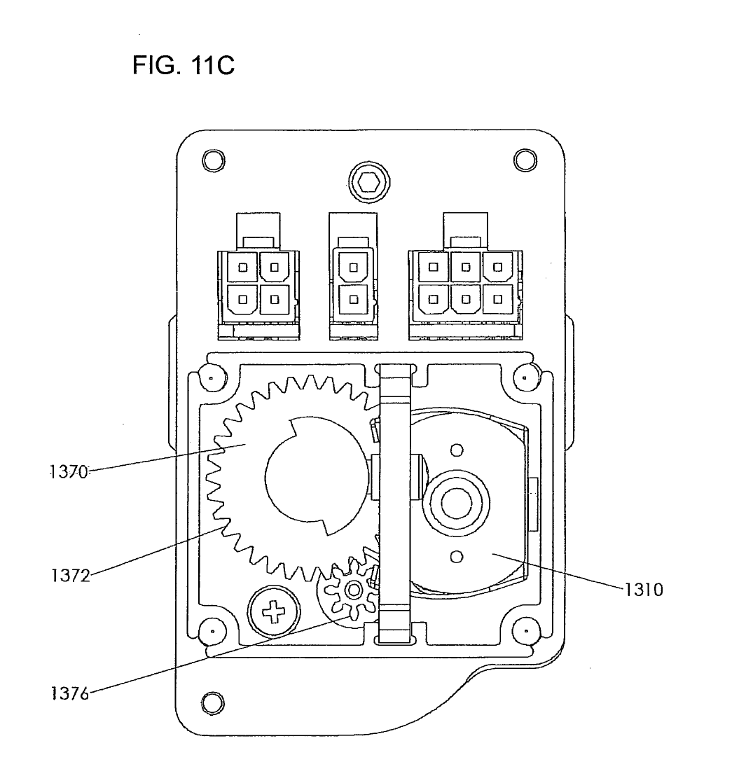

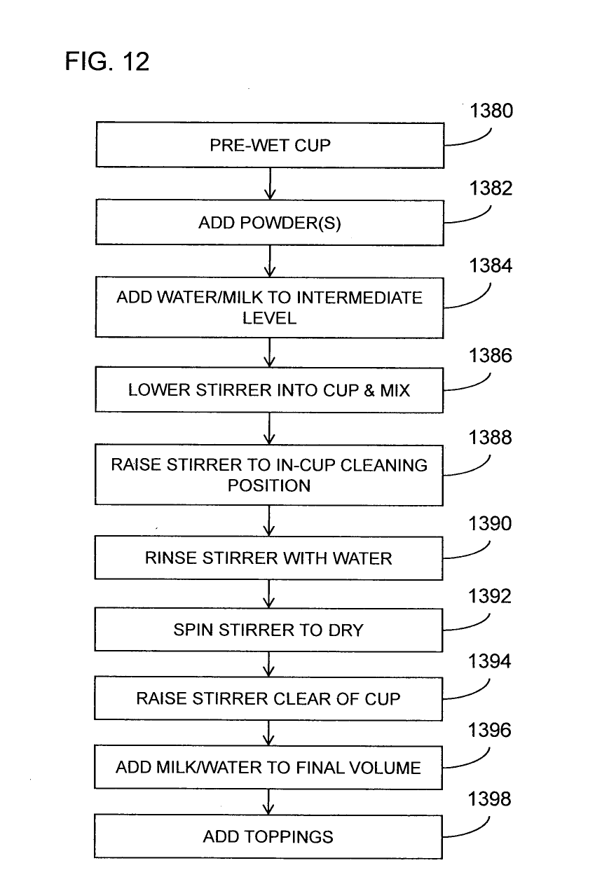

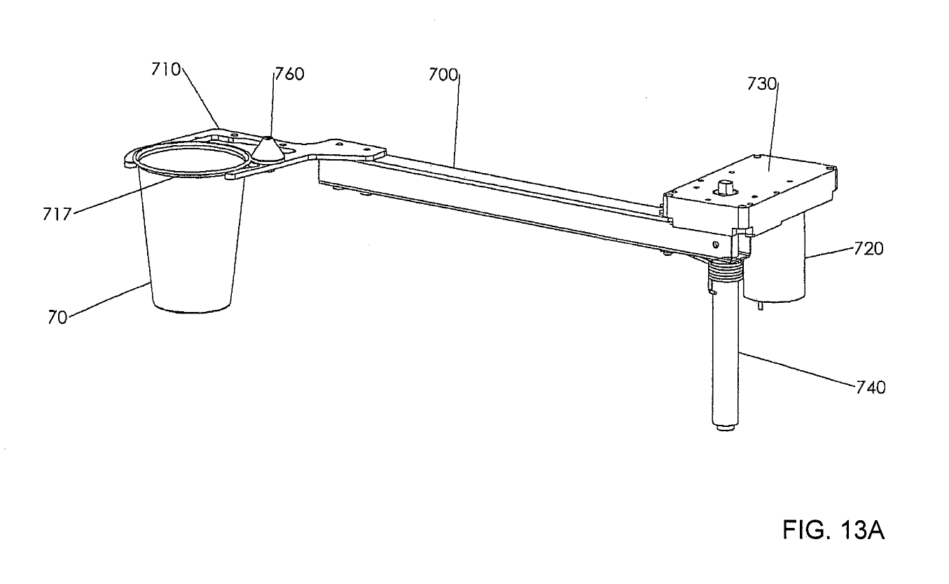

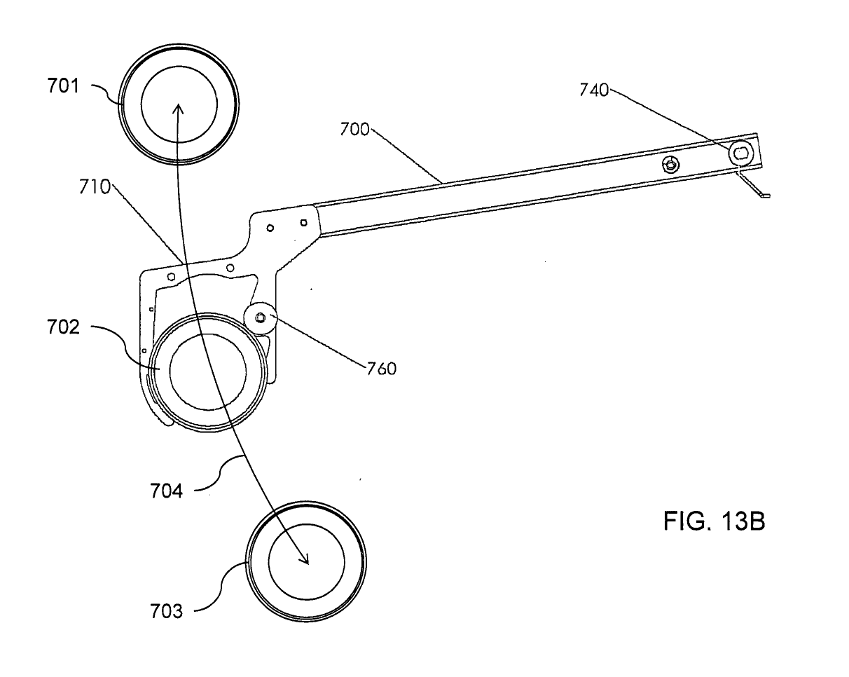

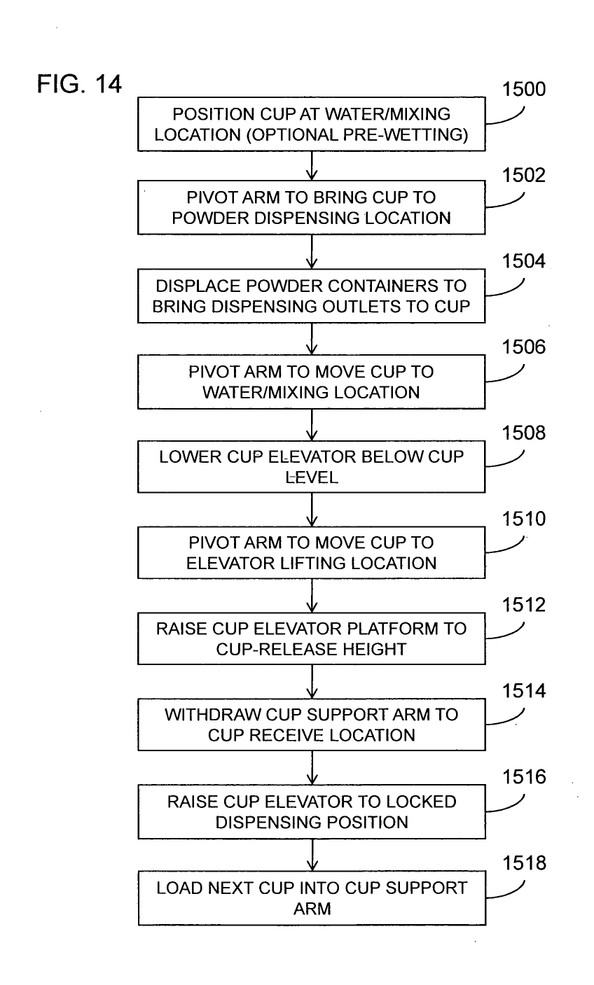

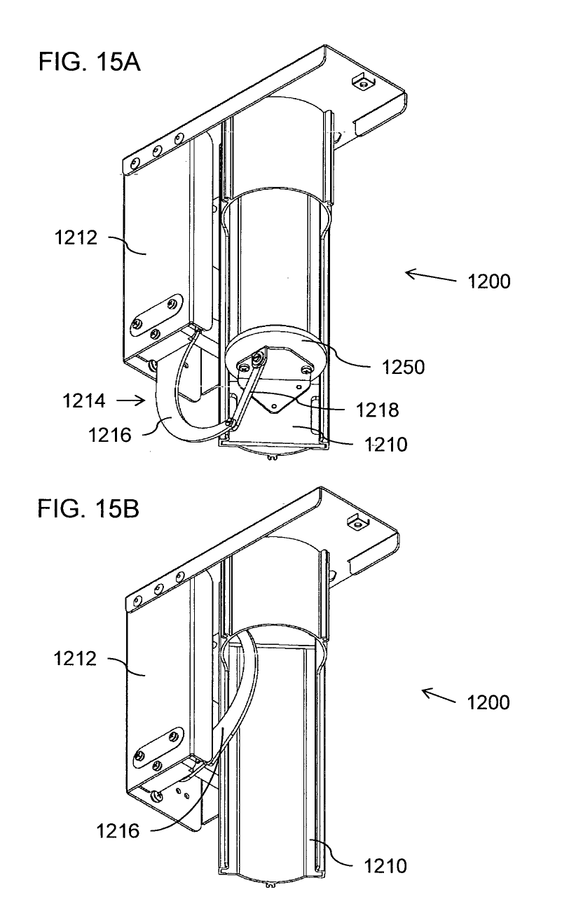

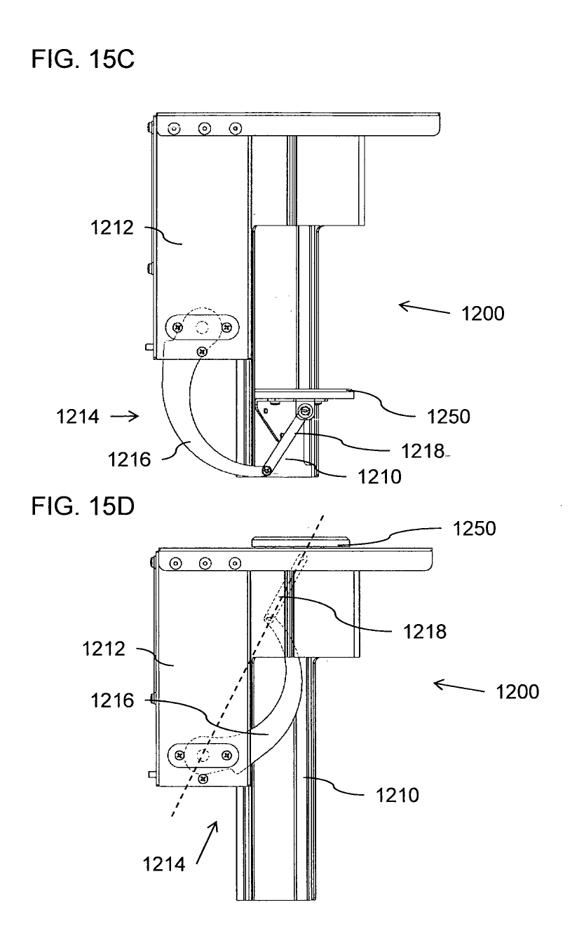

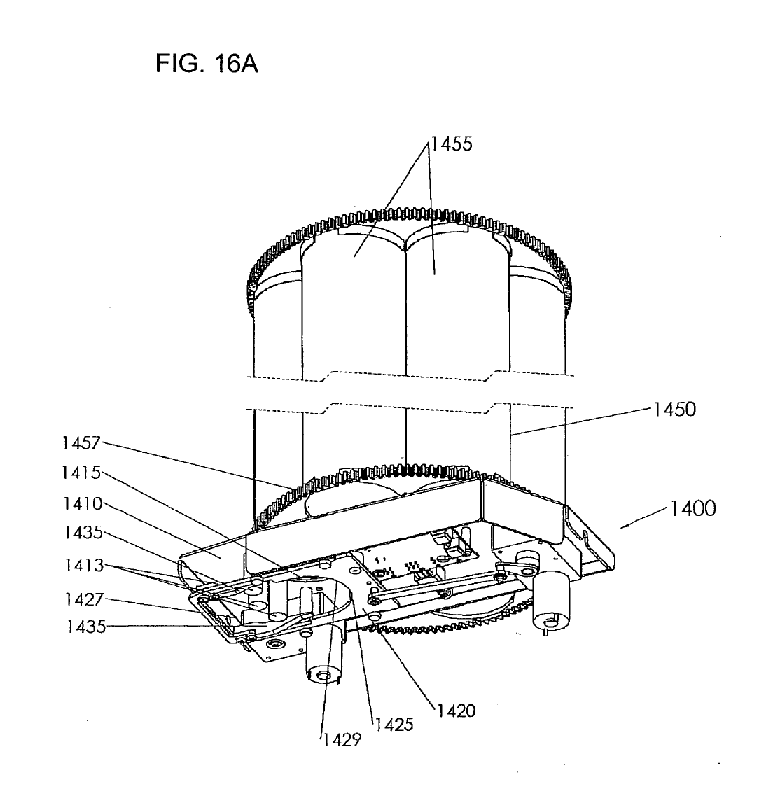

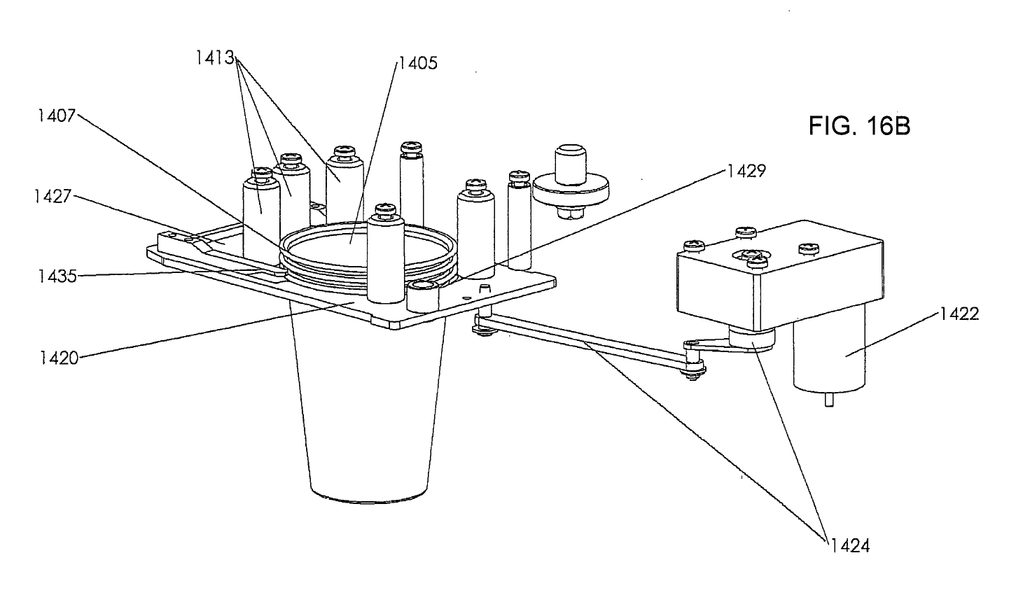

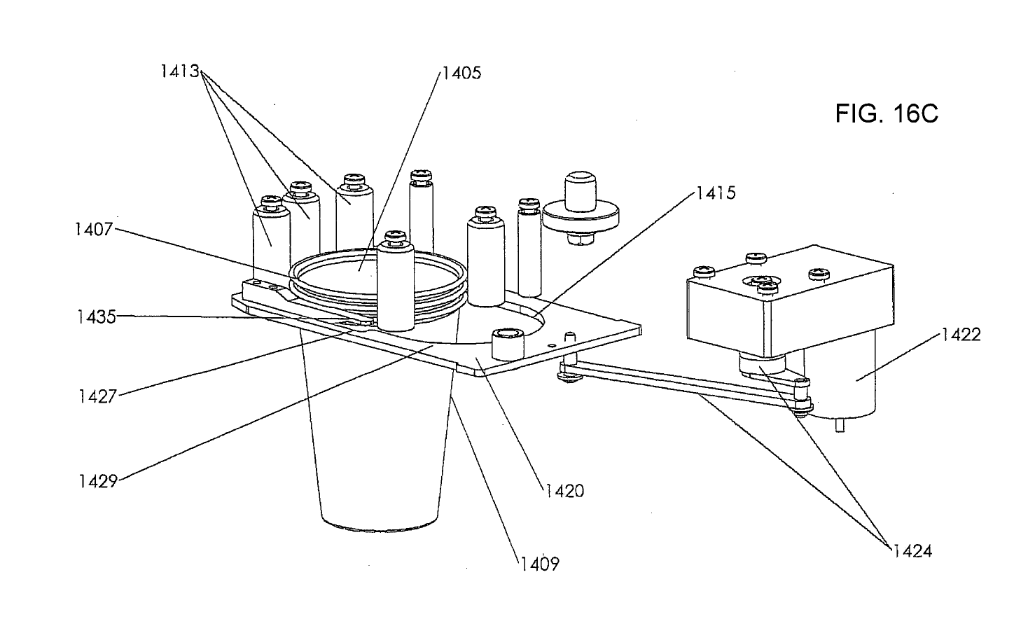

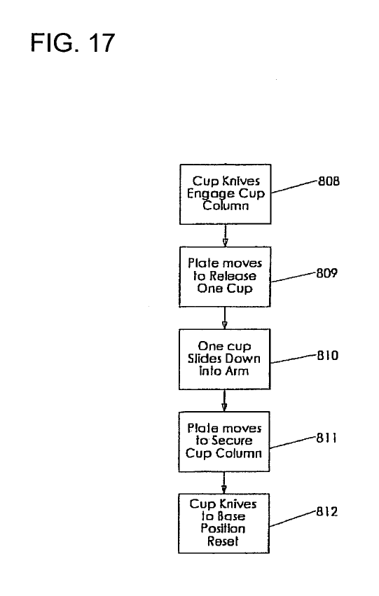

For clarity of presentation, the following description will be subdivided under separate headings relating to each of the subsystems of the beverage machine believed to be of particular significance. Specifically, a general overview of the structure and function of a particularly preferred embodiment of the beverage machine of the present invention will be given with reference to FIGS. 1A-1C and 2. Then, with reference to FIGS. 3A-3C and 4, a powder dispending system according to one preferred aspect of the present invention will be described. The structure and function of a water heater according to a further preferred aspect of the present invention will then be described with reference to FIGS. 5A-7F. Then, with reference to FIGS. 8-10D, a milk storage and delivery system according to a further aspect of the present invention will be described. The structure and function of a mixer according to a further aspect of the present invention will then be described with reference to FIGS. 11A-12. The remaining figures relate to various aspects of a cup conveyance arrangement according to a further aspect of the present invention: FIGS. 13A-14 relating parts of a cup conveyance arrangement employing a pivotally mounted cup support arm; FIGS. 15A-15D relating to an implementation of a cup elevator; and FIGS. 16A-17 relating to a cup dispensing system.

### System Overview

Referring now to the drawings, FIGS. 1A-1C provide an overview of the structure of a particularly preferred but non-limiting embodiment of an automated beverage vending machine, generally designated 100, constructed and operative according to the teachings of the present invention, while FIG. 2 provides an overview of the operation of the machine.

Referring now to FIGS. 1A and 1B, there are shown, respectively, a front view and a simplified internal view of a machine 100. Drink vending machine 100 includes a number of subsystems to handle various tasks/functions involved in preparing and dispensing drinks to users. Among the primary subsystems shown in FIG. 1B are a cup dispensing system 11 including a cup magazine 1450 and a cup release unit 1400 to supply a cup in which to prepare a drink, drink ingredients carousel 300 to select and supply the ingredients for the drink chosen by the user, water heater 500 to supply hot water at the required temperature for the drink chosen by the user, cup transport arm 700 to convey a cup 70 (received from cup dispensing system 11 via a cup directing funnel 1439) between the different stations in drink preparation and dispensing, mixer 1300 to mix the drink in cup 70, and cup elevator assembly 1200 to bring cup 70 with the drink prepared therein to the cup exit station 745 (FIG. 1A) where it is dispensed to the user. Drink vending machine 100 further includes a water cooler 7 to chill water for cold drinks selected by the user. A cold milk dispensing apparatus 1000, which supplies cold milk for drinks chosen by the user that require cold milk, may have its own cooling system or may share a cooling system with cooler 7. Carousel 300 has an associated powder dispenser drive 350 to actuate dispensing of the powdered ingredients for the drink chosen by the user, as will be explained hereinbelow. Drink vending machine 100 has a controller 12 including at least one processor to control the various functions performed by the various subsystems in drink preparation and dispensing, and drainage well 8 to catch and hold for disposal any unused residues of drink ingredients.

Referring now to FIG. 1A, there are shown additional features of drink vending machine 100. The present embodiment includes a keypad and display 112, allowing a user to choose a beverage, and a payment unit including a card reader 114 and a coin slot 116, providing the user with means to pay for the chosen beverage. At the end of the process, the prepared beverage is delivered to the user on cup elevator platform 1250 at cup exit station 745.

FIG. 1C shows the main functional blocks of machine 100 in more schematic terms, not all of which are readily visible in the views of FIGS. 1A and 1B. A power supply 120 provides power to controller 12, and preferably thereby indirectly to all the remaining powered components of machine 10. As mentioned, controller 12 includes at least one processor 12a, and preferably includes a communication system 12b to facilitate a modular assembly approach to implementation and assembly of all the subsystems of machine 100. The communication system 12b may be any suitable standard of dedicated communications bus architecture, or may be any other local area networking (LAN) architecture, with suitable complementary communication components (not shown) where necessary incorporated with each subsystem, all as will be clear to one ordinarily skilled in the art of computers and networking. Most preferably, each of the subsystems is configured to make all of its electrical connections, including power supply and control signals, through a single connector, and all the connectors are interchangeably connectable at any location in an arrangement of corresponding sockets. This renders assembly and servicing of the machine very straightforward.

The functional blocks connected to controller 12 include the keypad and display 112, the payment unit 115 (providing the aforementioned card reader 114 and coin slot 116 of FIG. 1A), cup dispensing system 11, and a cup conveyance arrangement 122 including arm 700 and cup elevator 1200. A lighting system 124, providing an illuminated face panel with suitable advertising graphics or the like, also draws power by connection to controller 12. Also connected to controller 12 are the powder dispensing system 126, including the drive 128 for carousel 300 and the powder dispenser drive 350, mixer 1300, water heater 500, milk delivery system 1000 and water cooler 7.

Keypad and display 112, payment unit 115 and lighting system 124 may be implemented as “off-the-shelf” commercially components, modified only to provide the modular form of interconnection to controller 12 described above, or can be purpose designed based upon well developed and publicly available technology for these purposes. Similarly, water cooler 7 may be implemented as a standard self-contained water cooler commercially available for such applications, preferably with an “ice bank” thermal accumulator. The remaining subsystems of machine 100 will be discussed further below, each under its own heading.

Controller 12 may be a general purpose computer operating with any suitable operating system and application software, as dedicated hardware, or as any combination of hardware, software or firmware, all as is well known in the art. The controller 12 may be subdivided into a number of separate units. In one preferred example, certain dedicated control components reside within the individual subsystems and are responsive to control signals from a central portion of controller 12 to actuate the local subsystem as required. All such implementations and subdivisions of controller 12 fall within the scope of the present invention. Details of the implementation will be clear to one ordinarily skilled in the art from the description of the operation of the system and its components below, and no detailed discussion of circuitry or software is considered necessary.

The overall operation of drink vending machine 100 is illustrated in FIG. 2. Specifically, a user first inputs an order for a drink of his or her choice via keyboard and display 112 (step 130) and effects payment which is verified by payment system 115 (step 132). Controller 12 translates the order into a sequence of steps and actuates the various subsystems (cup conveyance arrangement 122, powder dispensing system 126, water heater 500, milk delivery system 1000, water cooler 7 and mixer 1300) in order to prepare the drink (step 134). Controller 12 then actuates cup conveyance arrangement 122 to deliver the drink to the user (step 136) and actuates cup dispensing system 11 to prepare a cup for dispensing the next drink (step 138).

As mentioned, machine 100 described thus far is a particularly preferred but non-limiting example which illustrates the various novel subsystems of the present invention used to advantage in synergy. However, each of the subsystems described below is susceptible to a wide range of applications in other contexts independent of the other features of machine 100, as will become clear.

### Powder Dispensing System

FIGS. 3A-3C show in more detail the structure of powder dispensing system 126, constructed and operative according to the teachings of an aspect of the present invention. Powder dispensing system 126 (or more briefly, “powder dispenser 126”) marks a significant shift from the conventional approach for storing and dispensing powders for beverage machines and the like. Unlike the conventional fixed powder containers, this aspect of the present invention provides a conveyor arrangement, most preferably in the form of a rotary support mechanism or “carousel”, which brings the dispensing outlet of each container in turn to a dispensing location. This arrangement greatly simplifies the cup conveyance requirements for a mix-in-cup system, as will be detailed below. At the same time, the carousel structure presented here allows the use of tall storage containers with corresponding large capacity. The carousel structure is typically more compact for a given number of containers and quantity of stored powder than a comparable machine with side-by-side rectangular powder bins, allowing the resulting machine to have a smaller footprint.

Thus, referring to FIGS. 3A-3C, there is shown a powder dispenser 126, constructed and operative according to the teachings of an aspect of the present invention, for a beverage machine. Generally speaking, powder dispenser 126 includes a plurality of powder containers or “bins” 310 each having an opening 312, shown here with a hinged cover, to allow refilling powder container 310. As best seen in FIGS. 3B and 3C, at the base 320 of each container is a dispensing mechanism 325, typically with a rotatable screw drive or “auger” 330, for dispensing powder from the container via an outlet 335. A rotary support mechanism 315 supporting the plurality of powder containers 310 is rotatable about a substantially vertical axis 317. Powder containers 310 are deployed such that, for each powder container 310, a corresponding position of rotary support mechanism 315 brings the outlet 335 of that powder container to a common dispensing location, designated by arrow 336.

Powder containers 310 are preferably formed with a pair of non-parallel walls such that, when deployed on the rotary support mechanism, the pair of walls extend substantially radially relative to the vertical axis. Most preferably, each container 310 has a horizontal cross-sectional shape corresponding substantially to a sector of a circle, so that the containers can be compactly and efficiently arranged around the rotary support mechanism. It will be noted that the sector is incomplete to the extent that the inner point is typically truncated and rounded to avoid sharp angles likely to cause trapping of powder, and to leave room for structural support along central axis 317. The overall form of the resulting “carousel” 300 preferably corresponds substantially to a cylinder.

Outlets 335 are preferably located at a region of the corresponding powder container 310 proximal to vertical axis 317, i.e., nearer the central axis than the external periphery. This helps avoid unintended leakage from the outlet due to centrifugal effects when the carousel turns.

Containers 310 may be formed together as a unit, but are more preferably formed as separately mountable containers to facilitate servicing and cleaning. Each container may be a single unit, or may be assembled from multiple components, for example, with base 320 formed separately. Most preferably, between about 8 and about 18 containers are provided. In certain cases, particularly for ingredients likely to be used in small quantities or very large quantities, varying widths (angular size) containers may be used. For example, half-width or double width containers may sometimes be used. In most cases, however, it is considered preferable to employ interchangeable and identical containers, where necessary filling two containers with the same ingredient.

Bases 320 are preferably formed with suitably inclined surfaces to enhance gravity induced feed of powder to dispensing mechanism 325. Secondary feed-enhancing arrangements, such as an agitator wheel (not shown) associated with auger 330 may be provided, as is known in the art. It should be noted that the motion of the containers themselves according to this aspect of the present invention contributes to dislodging accumulated powder and facilitating gravity feed of the powder to the dispensing mechanism.

Parenthetically, although referred to herein according to its primary use as a powder dispensing system, it should be noted that the ingredients dispensed by powder dispensing system 126 are not limited to powders. Thus, by way of example, various toppings may be provided, such as croutons for soup, candy “sprinkles” for milkshakes. Similarly, the system may be used to dispense breakfast cereals or other ingredients or products with larger particle sizes not normally referred to as “powders”.

The angular position of carousel 300 is controlled by a suitable motor drive arrangement (not shown) engaged with the gear teeth around the edge of rotary support mechanism 315. Exact positioning may be achieved by use of an accurate stepper motor, by employing an optical or other type of encoder, or by any other suitable control modality, all as is well known in the art of mechanical device automation.

In particularly preferred implementations of powder dispensing system 126, the motion of the system is used to advantage to avoid the need for separate actuators for each dispensing mechanism 325. Instead, powder dispenser drive 350 is implemented as a drive arrangement including an electric motor 362 (only the housing being visible) and configured to selectively engage the dispensing mechanism 325 of each powder container 310 when it is located with its outlet 335 at common dispensing location 336. In the preferred example illustrated in FIGS. 3B and 3C, motor 362 rotates a drive linkage which is displaceable towards and away from dispensing mechanism 325 so as to selectively engage (FIG. 3C) and release (FIG. 3B) driving connection between the drive arrangement and the dispensing mechanism with which it is aligned. Motion of the drive arrangement is achieved by rocking of a rocker arm 360 about a pivot axis 365 through displacement of point 367 by a linear actuator (not shown) associated with motor 362. Rotary motion is transferred from motor 362 to a drive rod 370 of the drive arrangement via a built-in gear arrangement 363 within which drive rod is axially free to move. At the other end of the drive arrangement and on the outside of dispensing mechanism 325 there is provided a complementary plug and socket arrangement configured to engage each other to provide rotary engagement. In the case illustrated here, the drive arrangement has the plug 355 while each of dispensing mechanisms 325 features a complementary socket 340 fixed so as to rotate with auger 330.

According to a further particularly preferred feature of the implementation shown here, at least part of the rotary drive linkage between drive rod 370 and plug 355 is formed from a helical spring 375 deployed to accommodate variations in alignment between the drive arrangement and dispensing mechanism 325. In this case, one end 377 of helical spring 375 is fixed to drive rod 370 while the other end 372 is fixed to plug 355. Helical spring 375 is effective to transfer rotation to auger 330 for dispensing powder from outlet 335, but can accommodate a certain degree of transverse misalignment between the drive arrangement and socket 340.

Turning now to FIG. 4, this shows the operation of powder dispensing system 126. First, at step 401, the user chooses a beverage. Controller 12 then selects the container 310 containing the first or only “concentrate/powder” required for the chosen beverage (step 402) and rotates rotary support mechanism 315 so that its outlet is aligned over the common dispensing location (and cup) 336 (step 403). The linear actuator is then actuated to engage plug 355 of the rotary drive linkage with socket 340 of the selected bin (step 405) and motor 362 is actuated to turn socket 340 and hence also auger 330 so as to dispense the required amount of powder through outlet 335 (step 406). Then, at step 407, if another ingredient needs to be dispensed, steps 402 through 406 are repeated for the next ingredient. When all dry ingredients have been dispensed, water is added and the drink mixed (step 408, described further below) and the carousel is optionally returned to a default position, for example, with the container containing the most popularly used powder aligned with the dispensing location (step 409).

### Water Heater

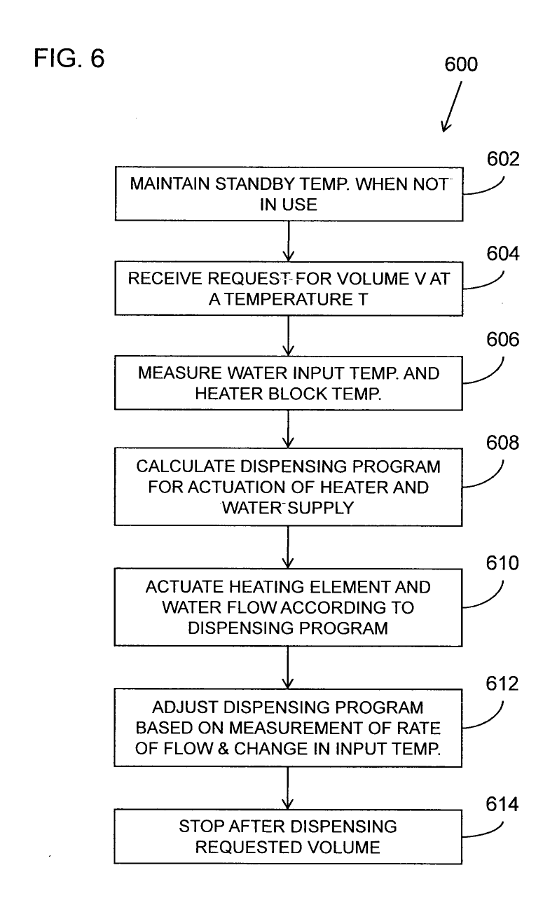

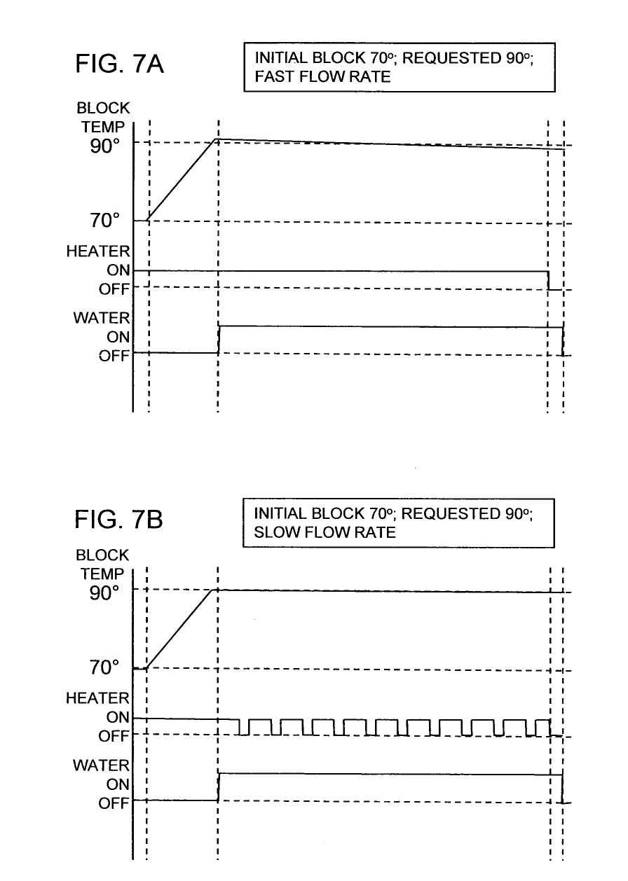

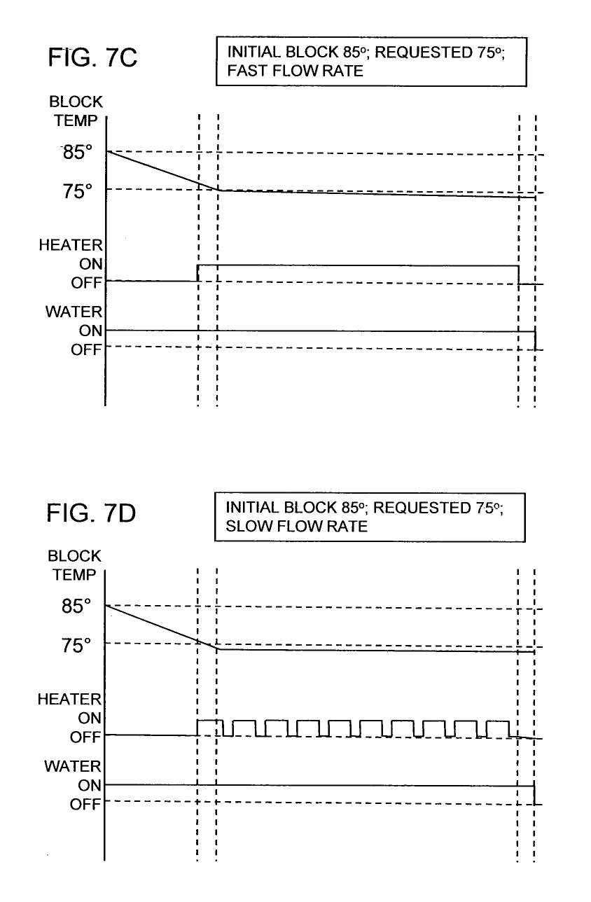

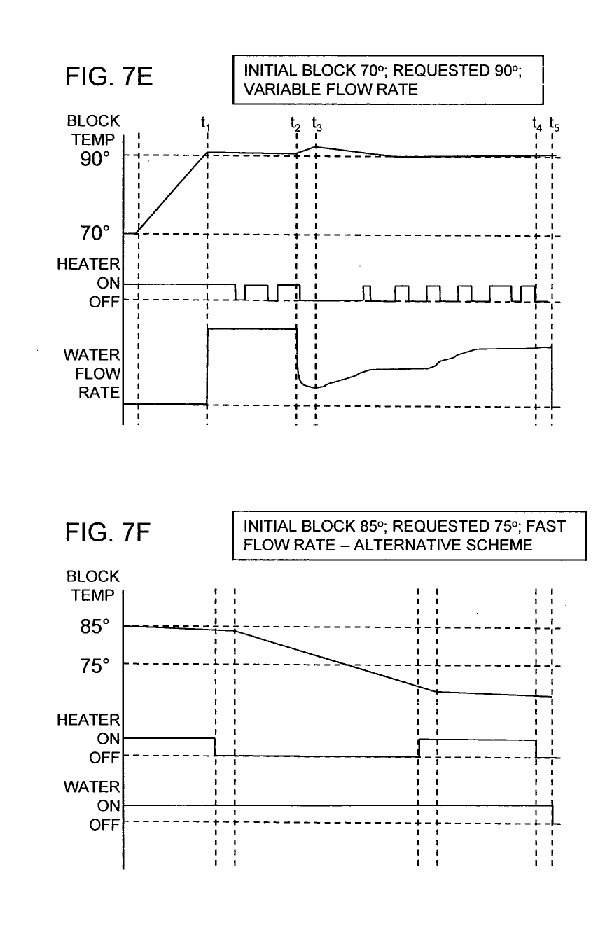

A particularly preferred embodiment of water heater 500, constructed and operative according to the teachings of an aspect of the present invention, will now be described with reference to FIGS. 5A-5F, and a preferred method of operating the water heater will be described with reference to FIGS. 6-7F. It should be noted that both the device and the method of operation are applicable in a wide range of applications not limited to the context of an automated beverage machine, particularly in any situation which requires dispensing of portions (e.g., cups) of hot water intermittently, such as, for example, a domestic counter-top or under-sink unit for dispensing a cup of hot water on demand. Certain aspects of novelty of the water heater are also applicable independently in the context of otherwise conventional water heaters, as will become clear. Furthermore, although described in the preferred context of heating water, the structure and method of the present invention may equally be used to heat other liquids.

A first aspect of novelty of water heater 500 relates to a particularly simple and low-cost structural implementation, and specifically, a structure which lends itself to mass production by low-cost production techniques. Thus, referring now to FIGS. 5A-5F, in the preferred implementation shown here, water heater 500 includes a thermal conduction block 510 formed from a metallic material. A plurality of though-bores 502, 504 and 506 extend through the thermal conduction block parallel to an extensional direction of block 510 from a first end surface 540 to a second end surface 542. A first cover 570, in sealing engagement with first end surface 540, is configured to define connecting passageways 574 between pairs of through-bores 506. Similarly, a second cover 572 in sealing engagement with second end surface 542, is configured to define connecting passageways 574 between other pairs of through-bores 506. For clarity of presentation, first cover 570 is omitted in FIG. 5A. Through-bores 506 and connecting passageways 574 of covers 570 and 572 are configured to together define an elongated flow path 508 extending from a fluid inlet 522 formed in one of the covers (in this case, first cover 570) through a plurality of through-bores 506 to a fluid outlet 524 formed in one of the covers (in this case, again first cover 570). A heating element 516 is associated with thermal conduction block 510, preferably by deployment within a central through-bore 502.

It is a particular feature of certain particularly preferred implementations of this aspect of the present invention that a cross-sectional form of the thermal conduction block taken perpendicular to the extensional direction (for example, as cut in FIG. 5C) is substantially invariant along a length of the thermal conduction block. When combined with the use of suitable material, such as aluminum, this allows production of block 510 by mass production techniques, and most preferably by extrusion. Covers 570 and 572, which do not need high thermal conductivity, are preferably formed from polymer materials by low-cost mass production techniques such as injection molding. The result is that the per-unit cost of the primary components of water heater 500 is typically significantly lower than conventional structures with heat-exchange blocks.

In the implementation shown here, additional through-bores 504 are provided in block 510. Some of these are aligned with corresponding bores 505 in covers 570 and 572 for clamping together the heater structure using elongated bolts 514 (FIG. 5A). At least one additional one of through-bores 504 is preferably used for insertion of a temperature sensor 515 (FIG. 5B), thereby allowing measurement of the temperature of the block when at steady state. Temperature sensor 515 may be of any suitable type, including but not limited to, a thermistor and a thermocouple.

Covers 570 and 572 are generally similar, other than that inlet 522 and outlet 524 are formed only in one or other of the covers, and that one of the covers features an additional opening for insertion of heating element 516. Most preferably, the opening for heating element 516 is formed in the cover closest to the electronic components (described below) to facilitate connection to the power supply, whereas the inlet and outlet are formed in the opposite end in order to facilitate access. Clearly, connecting passageways 574 are also suitably staggered between the covers to define the desired elongated flow path 508.

Additional elements associated with water heater 500, most preferably on the inlet side of the flow path in order to be exposed to low temperature liquid flow, are a flow meter 576 deployed to measure a rate of flow of liquid through elongated flow path 508, and a valve 578 deployed to control flow of liquid through elongated flow path 508, typically as an on/off flow control. These components may be located in the flow path as separately housed components as shown, or may optionally be integrated within one or other of first and second covers 570 and 572.

Elongated flow path 508 in which the long effective path typically extends along at least eight lengths of block 510. According to some embodiments, there are at least twelve through-bores 506 in the flow path, and according to some further embodiments, at least 18.

Thus, for example if block 510 has a length of 40 cm and there are 18 through-bores 506 in the flow path. the elongated flow path 508 has an effective length of about 7.2 m. The cross-section of through-bores 506 multiplied by the effective length defines the volume of fluid which is in the water heater at any one time. Thus, in cases where through-bores 506 are cylindrical and have a diameter of 2 mm, the total volume of conduit 506 is approximately 20-30 ml. If the diameter is 4 mm, the volume is approximately 80-100 ml. Typically, the diameter is between 0.5-6 mm, and more preferably between 1-4 mm.

The inlet 522 is in fluid connection with a source of cold water (not shown). The water outlet port 524 is in fluid connection with a hot water conveying conduit (not shown) which is conveys the hot water to the intended point of use, such as a cup 70 held in cup transport arm 700 (see below).

Heating element 516 is configured to be placed inside central through-bore 502 in close-fit connection therewith so as to allow for the conduction of heat therefrom via block 510 to through-bores 506 to heat the liquid therein.

Also shown here are various electronic components, generally designated 527, which provide switched power to heating element 516 and valve 578, and which receive inputs from flow meter 576 and temperature sensor 515. In most preferred cases, the electronic components include a processor and serve as part of a control system, such as aforementioned control system 12, providing various functionality to be described below. Here again, the details of various possible implementations of electronic components 527 (e.g., general purpose processor with software or dedicated hardware etc.) will be self-evident to one ordinarily skilled in the art on the basis of the functionality described below, and will not be addressed here in detail.

A further optional feature of water heater 500 visible in FIG. 5A is a scale reduction arrangement. Deposition of scale from hard water is a well known problem plaguing water heaters. In the case of the present invention, heating of a moving flow of water is typically effective to inhibit deposition of scale. However, during periods between dispensing portions of water, the water is temporarily stagnant, and scale deposition may occur. To inhibit this scale deposition, certain particularly preferred implementations of this aspect of the present invention include a recirculation scale inhibiting arrangement including a magnetic scale-inhibitor 590 deployed as part of a circulator arrangement 592 including a pump (not shown separately, and optionally combined within magnetic scale inhibitor 590). Circulator arrangement 592 forms a secondary flow path connecting between two points along the primary flow path of the heater and passing through magnetic scale-inhibitor 590. A controller, preferably implemented as part of electronic components 527, is configured to intermittently actuate the pump to circulate liquid in the primary flow path through the magnetic scale-inhibitor. In particular, the controller preferably actuates the pump selectively during periods when no flow is passing through outlet 524.

Although described here in the context of the particularly preferred structure of water heater 500, it should be noted that the scale reduction arrangement is equally applicable to a wide range of liquid heaters in which water is heated as it passes along a primary flow path from an inlet to an outlet, and in which flow is intermittent.

Turning now to the method of operation of heater 500 according to further particularly preferred implementations of the present invention, this aspect of the present invention addresses a situation where the thermal inertia of the heater is sufficient to accommodate flow rates greater than the rating of the heating element could heat from room temperature under continuous flow conditions, but, on the other hand, is small enough that the heat taken by each dispensed portion of liquid is not negligible compared to the thermal inertia of the heater. In quantitative terms, certain preferred implementations of block 510 together with the quantity of water contained within elongated flow path 508 have a total heat capacity not exceeding 1 kJ/K, wherein a majority of the heat capacity is in the block. As a result of this relatively low heat capacity, a readily available power supply, such as 2 kW, is sufficient to raise the block temperature by as much as two degrees per second, rendering it feasible to vary the temperature of each successive cup dispensed according to the particular needs of the consumer.

A major technical challenge of implementing a system with relatively small heat capacity is that thermostatic control is unreliable. The time lag between switching on power to the heating element and detecting a change in the output temperature of the water is such that overshoot of the intended temperature is almost inevitable. This situation is made worse by possible uneven temperature distribution which makes it difficult to accurately measure the temperatures when not in steady state conditions. When dealing with water temperatures above 90 degrees Celsius, such overshoot may lead to boiling of water with associated pressure build-up and hazards.

To avoid this problem, this aspect of the present invention provides an approach based upon calculation of the required energy supply based upon parameters determined prior to beginning dispensing of the portion of water.

Specifically, referring to FIG. 6, there is illustrated a method 600 for delivering portions of hot liquid on demand. The method relates particularly to heaters including a thermal conduction block, and at least one passageway through the block at least partially defining an elongated flow path from a heating arrangement inlet to a heating arrangement outlet, such as for example heater 500 described above. The elongated flow path has a predetermined contained volume designated V₀.

The method begins by preheating the thermal conduction block together with the liquid in the elongated flow path to a raised (i.e., above ambient) temperature T₀. Where the heater has not recently been in use, this is done by maintaining a standby temperature (step 602), typically somewhat below the range of temperatures to be dispensed in order to minimize energy losses. When the heater has recently been in use, the raised starting temperature T₀ will be whatever temperature block 510 happens to be at after the previous dispensing operation.

Then, at step 604, the system/method receives a request for dispensing a volume V of liquid at a temperature T. It should be noted that the “request” may simply be the fact that a unit of hot water needs to be dispensed (for example, where the values of V and T are fixed) or may contain data defining one or both of V and T for each portion requested.

At step 606, the raised starting temperature T₀ and the input temperature of the water T_{IN} are determined or defined. Most preferably, both T₀ and T_{IN} are measured by suitably placed temperature sensors. However, in certain cases, the value of T_{IN} may be assumed to be a suitably defined constant.

Then, at step 608, a dispensing program is calculated. The dispensing program includes a program for the actuation of the heating element to supply heat energy to the liquid in coordination with allowing liquid flow through the elongated flow path, and is based at least in part on parameters V, T, V₀, T₀ and the measured or assumed input temperature T_{IN} of the liquid. It should be noted that the “program” may be based upon an assumed or most recently measured flow rate, or may be defined parametrically as a function of the flow rate to be measured during dispensing. Then, at step 610, the portion of liquid is dispensed through the outlet by actuating the heating element and allowing liquid flow through the elongated flow path according to the dispensing program.

In certain cases, particularly where water supply conditions are very uniform, or where a flow rate regulation device is installed, the dispensing program may be implemented based on prior calculation without any real-time feedback. More typically, at least the rate of flow, and preferably also the input temperature of the water supply, are measured in real time, and correction is performed to the dispensing program if needed (step 612). It should be noted however that output water temperature is not used for real time feedback due to the aforementioned problems of time lag and overshoot. Instead, the amount of heating performed is based primarily upon the energy requirements as calculated from the input parameters with suitable adjustments to the calculations based on variations in flow rate and/or inlet water temperature. Finally, when the required volume has been dispensed, liquid flow is stopped at step 614. The method is repeated as required to provide successive portions of heated liquid.

These principles of operation will become clearer with reference to a number of specific examples described below with reference to FIGS. 7A-7F which illustrate dispensing programs as calculated and implemented. Referring first to FIG. 7A, this illustrates an example where block 510 and its contained water were preheated to a standby temperature of 70° C. and a cup of water is requested at 90° C. The graph shown here combines three different sets of information on the vertical axes: the temperature of block 510, the status of power to the heating element, and the status of the water flow control valve. The horizontal axis corresponds to elapsed time.

In this example, the dispensing program is subdivided into two stages: a first stage during which the temperature of thermal conduction block 510 is adjusted from temperature T₀ to within a given margin of the required temperature T; and a second stage during which the heating element is actuated as a function of a rate of flow of liquid through the elongated passageway to minimize temperature variations in the thermal conduction block while the liquid flows through the elongated passageway.

Thus, in this case, the dispensing program calls for immediate switching on of the heating element, prior to opening of the water flow control valve. After an initial time lag, the temperature of block 510 will start to rise. Under zero flow conditions, no new cold water is introduced, so heating of the block and contained volume V₀ of water is relatively fast, preferably rising from an initial 70° C. to the target of 90° C. within 10-20 seconds. The water flow control valve is then opened, allowing water to be dispensed from the elongated flow path. In this example, the flow rate is sufficient that the heating element cannot provide sufficient power to maintain steady state heating. Nevertheless, given the heat stored in the heat capacity of the block together with the partial offset of energy losses from the heating element, the gradient of temperature drop during dispensing is very gentle, and the output water temperature remains within an acceptable margin of the target value during dispensing. For maximum accuracy in the final cup temperature, the predicted temperature drop can be offset by calculating the initial heating period to bring the temperature of the block to just above the target temperature, as illustrated. Due to the aforementioned time lag, power to the heating element is preferably interrupted slightly before the interruption of water flow, also as illustrated.

Turning now to FIG. 7B, this shows a case similar to FIG. 7A except that the expected or measured flow rate is sufficiently low that the heating element can maintain steady state conditions during dispensing. In this case, the initial zero-flow heating stage is unchanged. During the second stage, power to the heating element is pulsed on and off in order to provide the mean power supply required to maintain steady state conditions.

It should be noted that the cases of FIGS. 7A and 7B may be distinct dispensing programs based upon a regulated or estimated flow rate, and with corrections made if flow rates subsequently vary. Alternatively, these two cases may correspond to a single parametrically defined dispensing program. In the latter case, the dispensing program may be expressed, by way of non-limiting example, in a form such as:
Stage I—valve closed; continuous heating at 2 kW for 13 seconds;
Stage II—valve open until 110 ml dispensed; pulsed heating at a rate of 2 kJ per 24 ml or at maximum rate of 2 kW while flow rate exceeds 24 ml/second;
Stage III—valve open until final 10 ml dispensed; heating element off.

Where real time measurements of inlet water temperature are available, stage II is preferably further parametrically defined with the heating rate expressed as a function of ΔT between the inlet temperature and the target temperature. Stage III may alternatively be defined in terms of a predicted time prior to completion of delivery of the requested quantity (in this case 120 ml) in order to more accurately reflect the time lag of the heating element.

Turning now to FIGS. 7C and 7D, these show situations where the starting temperature of block 510 after dispensing a previous portion is 85° C. and the requested cup temperature is only 75° C. In this case, in order to bring the temperature down to the target value, the dispensing program includes a first stage of dispensing water through block 510 prior to activating the heating element. As the cold water runs through block 510 without any external source of heating, cold water entering the block is heated to the block temperature, thereby rapidly absorbing energy from the block and lowering the block temperature towards the target temperature. Then, after sufficient water has flown through to lower the block to near the target temperature, heating begins depending upon the flow rate in a manner similar to that of FIGS. 7A and 7B, respectively. Here too, the dispensing program for the cases of FIGS. 7C and 7D may be separately defined based upon an estimated flow rate, or may be parametrically defined as a single flow-rate-dependent program analogous to the described above.

Turning now to FIG. 7E, this illustrates a scenario similar to that of FIG. 7B but where disruptions occur to the water supply pressure during dispensing, causing significant fluctuations in the flow rate. In this case, rather than a simple “on/off” indication, the water flow rate is plotted in quantitative terms.

During the first zero-flow stage, heating occurs as in FIG. 7B, and the system is clearly unaffected by variations in the supply pressure. Then at t₁ the flow control valve is opened and the flow rate is initially relatively constant. During this period, heating continues in regular pulses, again as in FIG. 7B. Then, at t₂, a sudden drop in flow rate is sensed by the flow meter. The system immediately interrupts heating since the volumetric quantity of the flow is not yet sufficient to require the next pulse. It will be noted that, due to the aforementioned heat transfer time lag, a small temperature peak occurs at t₃. However, since heating was already interrupted previously, almost immediately at t₂ and well before thermostatic feedback would have registered any problem, significant temperature overshoot is avoided. Heating then continues with variable pulse length and/or spacing between pulses to match the variable flow rate, thereby maintaining the target temperature throughout the dispensing process despite variations in flow rate.

Turning to FIG. 7F, it should be noted that the aforementioned approach in which the block is first brought near to the target temperature and then maintained near that temperature is only one of a wide range of modes of operation in which the heating method can be implemented. By way of one additional non-limiting example, FIG. 7F shows a case with the same starting parameters and requested output temperature and volume as that of FIG. 7C. In this case, however, a different dispensing program is used according to which the block temperature is maintained near its starting temperature of 85° C. for an initial period, then allowed to drop during non-heated heat exchange flow with the water flow until the block temperature approaches 65° C., and then during a final period the temperature is maintained near 65° C. The overall result is dispensing of a portion of water which, after mixing, will have a final temperature around the target value of 75° C. Such an option may be advantageous where the water is to be added to a material which is more effectively soluble in higher temperature water, or where a lower end temperature of the block is desired.

From the above examples, it will be clear that preferred implementations of water heater 500 and the corresponding methods of heating can provide individual temperature control for each portion dispensed. Most preferably, the range of temperatures which can be provided by the device spans a range of at least about 15 degrees Celsius, for example, from 75 to 95 degrees. For optimal power savings while keeping response time short, the standby temperature of the block when not in use is preferably within about 10 degrees below the lower end of the range; for example, around 65-75 degrees Celsius.

### Milk Delivery System

Turning now to FIGS. 8-10D, there is shown a milk delivery system, generally designated 1000, constructed and operative according to the teachings of a further aspect of the present invention, for storing and delivering milk from a container of milk to a cup or other point of use. Here too, it should be noted that milk delivery system 1000 is not limited to use in the context of an automated beverage machine, and could be used in a range of other contexts such as, for example, a free standing milk-on-tap arrangement for commercial or domestic applications.

In general terms, milk delivery system 1000 includes a housing 1002 having an enclosed volume 1004 for receiving one or more containers of milk 1006a and 1006b. In the case shown here, housing 1002 has a removable insulated lid 1003. A cooling conduit 1008 is deployed to define a flow path from enclosed volume 1004 to a point of delivery to a cup 70. Cooling conduit 1008 is formed from a thermally conductive material, i.e., a material chosen such that, when one end of the conduit is cooled, thermal conduction along the conduit is sufficient to effectively cool the entire conduit. The material is typically a metallic material, and most preferably, copper. A cooling arrangement, schematically represented by heat transfer element 1010, is deployed to cool enclosed volume 1004 and cooling conduit 1008. Most preferably, cooling arrangement 1010 is deployed to directly cool enclosed volume 1004, and cooling conduit 1008 is cooled via thermal coupling with the enclosed volume.

In order to avoid the need for extensive cleaning and disinfecting of the system, it is a particular feature of preferred implementations of milk delivery system 1000 according to this aspect of the present invention that all components coming in direct contact with the milk are single-use disposable components. To this end, milk delivery system 1000 includes a length of flexible tubing 1012a and 1012b removably insertable through cooling conduit 1008 so as to form a sealed flow path from each container 1006a and 1006b to the point of delivery to the cup. A part of flexible tubing 1012a and 10126 is received within a peristaltic pump 1014 configured for pumping milk from the containers 1006a and 1006b along the flexible tubing 1012a and 1012b to the point of delivery to the cup.

In order to maintain temperatures along the length of cooling conduit 1008 as uniform as possible, the portion extending outside housing 1002 is preferably provided with insulation 1018. In order to maintain the required storage temperature in the portion of the flexible tubing within peristaltic pump 1014, the pump is preferably deployed within enclosed volume 1004.

Most preferably, each length of flexible tubing 1012a and 1012b is formed with a dispensing nozzle 1016 configured to engage an end portion of cooling conduit 1008, thereby defining a fully inserted state of the flexible tubing. The dispensing nozzle preferably has a narrow outlet aperture so that a very small quantity of milk is retained within the aperture, and the nozzle is preferably formed to make extensive thermal contact with the end portion of cooling conduit 1008 so as to itself be cooled through contact with the nozzle. In this manner, all of the milk along the entire flow path from container to dispensing nozzle is effectively kept cool.

Particularly for unattended dispensing systems, such as automated beverage vending machines, housing 1002 is preferably configured to receive two containers of milk 1006a and 1006b as shown. In this case, cooling conduit 1008 is part of a conduit arrangement defining two flow paths from enclosed volume 1004 to the point of delivery to the cup. The conduit arrangement may have two separate cooling conduits 1008, or may have only one cooling conduit 1008 which is sufficiently wide to receive both lengths of flexible tubing. As mentioned, each container preferably has its own corresponding single-use length of flexible tubing which is removably insertable through the cooling conduit so as to each form a sealed flow path from one of the containers of milk to the point of delivery to the cup.

Where two containers and two lengths of flexible tubing are used, it is preferably that milk be drawn from one container until that container is finished, and only then the second container is started. This allows the empty container to be replaced during replenishing of the machine contents while the container currently in use remains until its contents are finished, and ensures that the milk with an earlier expiry date is used before the newer milk. To this end, milk delivery system 1000 preferably includes an optical sensing arrangement 1020 associated with each of the lengths of flexible tubing and configured to generate a signal indicative of the presence or absence of milk within each of the lengths of flexible tubing. Since milk is highly dispersive of light, optical sensing arrangement 1020 can be simply implemented, for example, as a LED 1022 transmitting light through the tube and any suitable type of photo-sensor 1024 deployed on the opposite side of the tube. A controller (not shown) is responsive to signals from optical sensor 1020 to maintain a selection of the container in use as long as the presence of milk in that tube is detected, and to switch to use of the other container whenever the absence of milk is detected. If absence of milk is detected in both tubes, a repeated attempt may be performed to draw milk from each container. If these attempts are unsuccessful, a “milk finished” error signal is generated and, in the case of an automated beverage vending machine, corresponding changes are made to the list of available beverage options.

According to one possible implementation (not shown), separately controlled peristaltic pumps may be provided for each length of flexible tubing. More preferably, both lengths of flexible tubing 1012a and 1012b have parts received within the same peristaltic pump 1014, and switching between the containers is achieved by a separate flow switching arrangement deployed upstream of the peristaltic pump and configured to selectively prevent flow in one or other of the lengths of flexible tubing. In the preferred case illustrated here, optical sensing arrangement 1020 and the flow switching arrangement are combined into a single unit deployed within enclosed volume 1004, shown in more detail in FIG. 9. In this case, by way of one non-limiting example, the flow switching arrangement is implemented as an eccentric rotating element 1026 which is turned so as to pinch one or other of the lengths of flexible tubing 1012a and 1012b against an opposing wall, thereby blocking it against through-flow of milk. Details of an actuator for rotating element 1026 are not shown, but will be clear to one ordinarily skilled in the art.

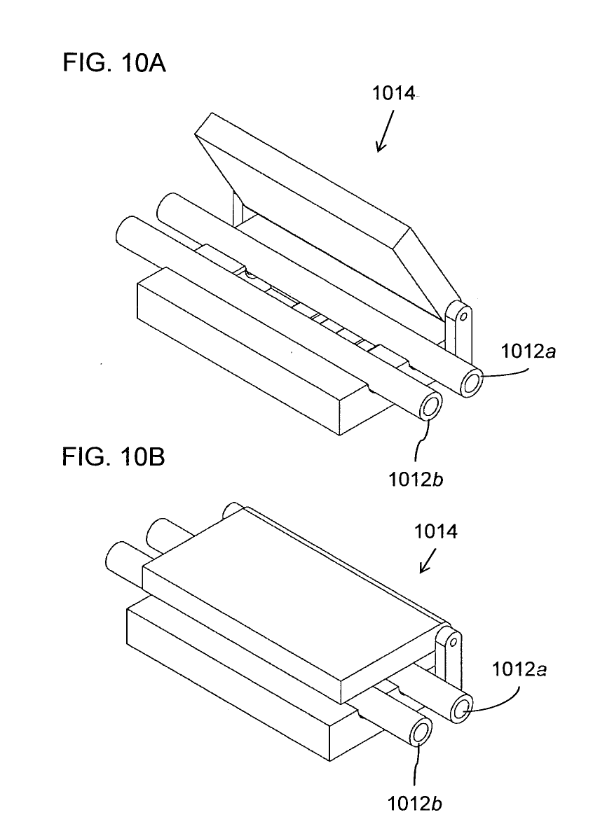

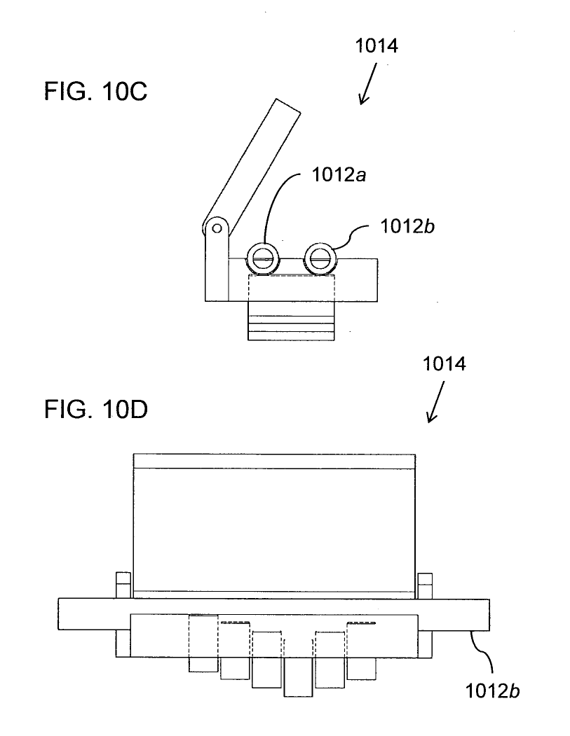

Turning now to FIGS. 10A-10D, there is shown a non-limiting example of peristaltic pump 1014. Generally speaking, peristaltic pump 1014 is similar in structure and function to peristaltic pumps commercially available for medical applications, for example, for controlling flow for intravenous (I.V.) drug delivery. Peristaltic pump 1014 differs primarily in that it has channels for receiving two lengths of flexible tubing in parallel. It will be noted that operation of the pump continues normally while one length of tubing is open and the other is occluded. The part of the occluded tube within the pump remains collapsed on itself since no additional liquid is available to refill the inner volume of the tube where pressure on the wall is released by the pump. Pumping of milk through the open tube continues as normal.

It should be noted that cooling arrangement 1010 may be implemented as a self-contained cooling system. However, in cases where milk dispensing system 1000 is used as part of a system also including a water cooler, cooling arrangement 1010 may optionally be implemented more efficiently by circulation of cooled water from the water cooler through milk dispensing system 1000 in a manner generally known in the art of refrigeration.

### Operation of Mixer

Turning now to FIGS. 11A-11C, there is illustrated an implementation of mixer 1300, constructed and operative according to the teachings of a further aspect of the present invention, for use in a mix-in-the-cup beverage machine such as machine 100 described above.

Mixer 1300 includes a motor 1310 mechanically connected to a mixing device 1320. Mixing device 1320 has a mixer head 1322 connected to a long vertical shaft 1324. Vertical shaft is moved up and down by a mechanism 1340. In one embodiment, shown in FIGS. 11A-11C, the mechanism includes a vertical screw shaft 1330 having a protruding screw thread 1332 and an interior shaft 1334. Protruding screw thread 1332 engages teeth 1336 of a vertical rotating means 1360. Means 1360 has an engaging abutment 1338 constructed and configured engage vertical shaft 1324. Motor 1310 is constructed to engage and rotate horizontal rotating means 1370 having teeth 1372. Rotating means 1370 is constructed and configured to be engage gear 1376.

Upon activation of motor 1310, rotating means rotates and is operative to move screw shaft downwards, which, in turn engages teeth 1336 and engaging abutment, which in turn engages vertical shaft 1324 and moves it downwards. It should be understood that motor 1310 is controlled by a processor (not shown) which controls the speed of movement of shaft 1324 in an upward and downward direction, as well as a speed of rotation thereof in a horizontal direction.

It should be understood that various changes to this configuration, such as there being vertical stations for the mixing shaft 1324 and associated mechanical designs are considered to be within the scope of the present invention.

Mixer 1300 is thus constructed and configured to move mixer head 1322 to a plurality of vertical positions as well as to rotate the head horizontally at various different speeds.

Turning now to FIG. 12, this illustrates a preferred method for operating a mix-in-the-cup beverage machine according to a further aspect of the present invention. Although the structure of mixer 1300 described above may be used to advantage for implementing this method, it should be appreciated that the method is applicable more broadly in any case where there is provided a mix-in-the-cup station including: a cup holder for holding a cup containing powder in a given position, a water supply arrangement for delivering water into the cup, and a mixer including a stirrer on a rotatable shaft which is axially displaceable downwards into the cup. Similarly, it should be noted that this aspect of the invention is not limited to details of the particular powder dispensing system or other details of machine 100 described herein.

In general terms, this aspect of the present invention provides for cleaning, or at least drying, of the stirrer between mixing operations by spinning the stirrer after lifting it out of the mixed contents of the cup. Dirtying of the machine is avoided by performing this spinning action at a height that is still enclosed by the walls of the cup.

Thus, after positioning a cup containing powder in the cup holder, the present invention performs the following steps: adding to the cup a quantity of water; lowering the stirrer into the water and spinning the stirrer so as to mix the contents of the cup; raising the stirrer to a position above the surface of the mixed contents but enclosed by the walls of the cup; spinning the stirrer so as to substantially dry the stirrer; and raising the stirrer out of the cup.

A fuller presentation of a particular preferred implementation of this aspect of the present invention is shown in FIG. 12. According to one optional feature, it may be desired to put a small quantity of water into the cup (step 1380) prior to dispensing powder, particularly where the powders used include very fine particles having a tendency to be dispersed in the air. Then at step 1382, the powder or powders required for mixing the desired drink are added to the cup. At step 1384, water and/or milk (according to the particular beverage program) is added to the cup to an intermediate level. The quantity is chosen to be sufficient for a full mixing of the ingredients but small enough to allow empty height within the cup for subsequent spin-drying of the stirrer. The stirrer is then lowered into the mixture in the cup and rotated to mix the contents (step 1386), and then raised to an in-cup cleaning position still enclosed by the walls of the cup (step 1388). Optionally, at this point, the water dispenser which is preferably aligned with this stirrer position may be actuated momentarily to rinse the stirrer with clean water (step 1390). This step is described as optional since it has been found that the spinning alone is sufficient to render the stirrer clean of all substantive contamination and dry to the touch. Nevertheless, an additional rinse is believed to be advantageous for certain applications. The stirrer is then spun at high speed, typically higher than used for the in-cup mixing, thereby cleaning and drying the stirrer (step 1392). The stirrer is then lifted away from the cup to its standby position (step 1394) and the remainder of the liquids (water and/or milk) required to complete the volume of the beverage to be dispensed are added to the cup (step 1396). Any optional dry toppings (e.g., croutons) are then added (step 1398) to complete preparation of the beverage.

### Cup Conveyance System

Turning now to the remaining FIGS. 13A-17, there are shown various features of a cup conveyance system and a cup dispensing system according to further aspects of the present invention.

By way of introduction, it should be noted that cup conveyance is a significant issue complicating implementation of mix-in-the-cup automated beverage machines. Specifically, each cup must be capable of being brought into alignment with each powder container dispensing outlet. This typically requires the use of a linear conveyor arrangement which adds complexity to the system. In contrast, the use of a conveyor system for bringing each powder container outlet into alignment with a common dispensing location, for example as described above with reference to FIGS. 3A-3C, greatly reduces the level of complexity imposed on the cup conveyance system. Thus, in certain particularly preferred implementations to be described below, cup conveyance during preparation of the beverage and dispensing to a user is achieved using only one pivotally movable sup supporting arm and one vertically movable cup delivery elevator, each actuated by a single motor.

Thus, according to one preferred aspect of the present invention, there is provided an automated beverage dispensing machine for providing a user with a drink in a cup, the automated dispensing machine including: a cup dispensing subsystem for dispensing a cup (for example, cup dispensing system 11 as will be described below with reference to FIGS. 16A-17); a powder dispensing subsystem for dispensing powder to a powder dispensing location 701 (for example, powder dispensing system 126 as described above with reference to FIGS. 3A-3C); a water dispensing subsystem for dispensing water to a water dispensing location 702 (for example, an outlet pipe providing water from water heater 500 described above with reference to FIGS. 5A-5F); and a cup conveyance arrangement configured for receiving a cup 70 from the cup dispensing subsystem and conveying the cup to the powder dispensing location and the water dispensing location, and subsequently providing the cup to the user.

In a particularly preferred implementation of this aspect of the present invention, the cup conveyance arrangement includes a cup supporting arm 700 (FIGS. 13A and 13B) mounted so as to be pivotally movable about a vertical axis 740, and a cup delivery elevator 1200 (FIGS. 15A-15D) having a vertically displaceable platform for delivering the cup along a vertical path of motion to the user. As best seen in FIG. 13B, it is a particularly preferred feature of this aspect of the present invention that powder dispensing location 701, water dispensing location 702 and a lifting location 703 on the vertical path of motion of elevator 1200 are all located on an arc 704 centered at vertical axis 740 such that pivotal motion of cup supporting arm 700 is sufficient to bring cup 70 to each of locations 701, 702 and 703.

In order to simplify the structure as much as possible, cup supporting arm 700 preferably has a rigid cup-gripping configuration 710, i.e., without any joints or moving parts, which firmly holds a cup 70, typically just below its rim 717.

Optionally, a conical or otherwise inclined alignment element 760 is provided as part of cup-gripping configuration 710 to help ensure accurate alignment of a cup 70 in its intended position. Cup-gripping configuration 710 is configured such that, when cup supporting arm 700 brings a cup 70 to the lifting location 703, partial raising of cup delivery elevator 1200 is effective to disengage cup 70 from cup-gripping configuration 710 and to allow pivotal motion of cup supporting arm 700 to move clear of cup delivery elevator 1200.

Angular displacement of cup support arm 700 about vertical axis 740 is preferably controlled by an electric motor 720 (FIG. 13A), typically through a built in gear arrangement 730. Exact alignment of cup support arm 700 in angular positions corresponding to the various required locations of cup 70 may be achieved by a number of well known techniques including, but not limited to, use of an accurate stepper motor for motor 720, use of microswitches or optical sensors to sense the presence of cup 70 at each location, and use of an angular encoder of any suitable type associated with the pivotal connection at axis 740. The control circuitry (not shown) to actuate and coordinate motion of support arm 700 and cup delivery elevator 1200, considered part of control system 12, may be located locally as part of the cup conveyance arrangement or may be included within a central unit of control system 12, as stated earlier.

As mentioned above, this cup conveyance arrangement is of particular significance when used in combination with a powder dispensing subsystem which includes a conveyor arrangement for displacing the powder containers to sequentially bring each of the powder dispensing outlets to powder dispensing location 701. A particularly preferred but non-limiting example of such as powder dispensing subsystem is powder dispensing system 126 as described above with reference to FIGS. 3A-3C.

This cup conveyance arrangement is also particularly intended for use with a mix-in-the-cup beverage dispensing machine. Accordingly, the machine typically includes a mixer having a vertically displaceable stirrer for stirring the contents of the cup at a stirring location. By way of one non-limiting example, the mixer may be implemented as mixer 1300 described above with reference to FIGS. 11A-11C. It is a particularly preferred feature according to certain implementations of this aspect of the present invention that the stirring location is located on arc 704. In one particularly preferred option, the stirring location is coincident with water dispensing location 702. In this case, location 702 may be referred to as a “water/mixing location”.

In certain cases, a further stopping location (not separately labeled) may be defined along arc 704 for loading of a cup from cup dispensing system 11.

FIG. 14 shows an exemplary sequence of operations performed by the cup conveyance arrangement during dispensing of a cup of beverage. Optionally, at step 1500, the cup may be brought to water/mixing location 702 for pre-wetting of the cup. Then, at step 1502, motor 720 displaces cup supporting arm 700 to bring the cup to common powder dispensing location 701. Before, during or after step 1502, the powder containers are displaced to bring the appropriate container dispensing outlet to powder dispensing location 701. When the powder dispensing outlet and the cup are aligned, the appropriate quantity of powder is dispensed (step 1504). If necessary, additional powder containers are brought into alignment and the appropriate combination of powders dispensed. Then at step 1506, cup supporting arm 700 is displaced to bring the cup back to water/mixing location 702 where water is added and mixing performed, for example according to the sequence of FIG. 12, until preparation of the drink is complete.

For conveying the drink to the user, cup elevator platform 1250 is first lowered to a position below the bottom of cup 70 (step 1508) and cup supporting arm 700 is rotated until the cup is positioned at lifting location 703 (step 1510). Elevator platform 1250 is then raised to a predefined cup-release height sufficient to partially raise cup 70 so that the walls of the cup disengage from cup-gripping configuration 710 (step 1512). Cup support arm 700 is then withdrawn to clear the path of elevator 1200 (step 1514) and the elevator platform 1250 is raised to its fully raised, locked dispensing position to deliver the drink to the user (step 1516). Finally, at step 1518, a new cup is fed by cup dispensing system 1400 to cup-gripping configuration 710 in preparation for dispensing of the next drink.

Turning now to FIGS. 15A-15D, there is shown a particularly preferred implementation of cup elevator 1200, constructed and operative according to the teachings of a further aspect of the present invention, for use as a cup delivery arrangement as part of an automated beverage dispensing machine. Cup elevator 1200 includes a platform 1250 for supporting a cup, a vertical linear bearing arrangement 1210 deployed to define a vertical path of motion of the platform 1250, and a drive arrangement including an actuator 1212 for moving a mechanical linkage 1214 so as to displace platform 1250 along the vertical path of motion from a lowered position (FIGS. 15A, 15C) to a raised dispensing position (FIGS. 15B, 15D). Mechanical linkage 1214 is configured such that, in the raised dispensing position of the platform, mechanical linkage 1214 assumes a geometrically locked state to oppose downward force applied to platform 1250.

More specifically, in the example shown here, actuator 1212 displaces a first arm 1216 through a pivotal motion, and mechanical linkage 1214 includes a second arm 1218 pivotally connected to first arm 1216 and to platform 1250. First and second arms 1216 and 1218 are configured to provide “over-center locking” in the locked state. In other words, as best seen in FIG. 15D, at the end of the raising motion, the point of pivotal interconnection between first and second arms 1216 and 1218 crosses over the line between the pivotal mountings of the remote ends of the arms. As a result, any force exerted to push platform 1250 downwards will tend to force arms 1216 and 1218 tighter into their fully raised locked state, thereby preventing forced lowering of the platform. This renders it more difficult for vandals or thieves to gain access to the interior of the machine via the dispensing opening.

Actuator 1212 can be any of a number of types of linear or rotary actuators or motors. Most preferably, a rotary motor with a suitable associated gear chain is used. Here too, accurate control of the position of platform 1250 may be achieved by any of a range of options that will be clear to one ordinarily skilled in the art including, but not limited to: use of an accurate stepper motor for the actuator; use of microswitches or optical sensors to detect the position of the platform; and use of a linear or rotary encoder of any suitable type associated with any of the angularly or linearly moving parts.

Turning finally to FIGS. 16A-16C and 17, there is shown a cup dispensing system, referred to alternatively as a “cup release unit”, generally designated 1400, constructed and operative according to the teachings of another aspect of the present invention. Cup release unit 1400 is operative to select and release a single cup from cup magazine 1450 for preparation therein of a beverage selected by a user. Cup magazine 1450 is a cup storage and supply arrangement, such as is currently known in the art, consisting of a circular array of tubes 1455, driven by a circular toothed ring 1457, each tube 1455 containing a column of cups for making drinks therein. Cup magazine 1450 is situated above cup release unit 1400 so that a column of cups from one of the tubes 1455 will be engaged therewith to release cups one at a time on demand as needed for drink preparation therein. Cup release unit 1400 has an upper plate 1410 with a hole 1415 large enough for a column of cups from a tube 1455 from cup magazine 1450 to pass through. Upper plate 1410 of cup release unit 1400 has an array of cylindrical bushings 1413 mounted thereon around hole 1415 to guide the column of cups vertically through cup release unit 1400 to cup holding plate 1420. Cup holding plate 1420 has an oblong hole 1425 with a wide portion 1427 and a thin portion 1429. Aligned with the sides of wide portion 1427 of hole 1425 is are cup knives 1435 which are attached to cup holding plate 1420 along both sides of wide portion 1427 of hole 1425.

Referring now to FIGS. 16B and 16C, there are shown two oblique views of cup holding plate 1420 engaging a portion of a column of cups 1405 which are aligned by bushings 1413. In FIG. 16B cup holding plate 1420 is shown to have been driven by cup holding plate motor 1422 and cup holding plate drive 1424 to a position wherein thin portion 1429 of hole 1415 engages the column of cups 1405. It should be note that the rims 1407 of cups 1405 are wider than thin portion 1429 of hole 1415 so that column of cups 1405 are caught and supported by thin portion 1429 of hole 1415. In FIG. 16C, cup holding plate 1420 is shown to have been driven by cup holding plate motor 1422 and cup holding plate drive 1424 to a position wherein wide portion 1427 of hole 1415 engages the column of cups 1405. Wide portion 1427 of hole 1415 is wider than rims 1407 of cups 1405 so that column 1405 of cups would be free to fall through wide portion 1427 of hole 1415. However, cup knives 1435 are aligned with the sides of wide portion 1427 of hole 1415 with a distance between them or a width equal to that of thin portion 1429 of hole 1415 and engage column 1405 of cups just above the bottommost cup 1409 of the column 1405, as can been seen in FIG. 16C. Thus column 1405 of cups, except for bottommost cup 1409 thereof are supported at their rims 1407 by cup knives 1435 and the bottommost cup 1409 is free to fall through wide portion 1427 of hole 1415 and through cup chute 1437 and cup guidance cone 1439 (see FIG. 1B) to be conveyed by cup transport arm 700 for preparing a beverage therein.

The operation of cup dispensing system 1400 is illustrated in FIG. 17 which shows the following steps:

| | |
|---|---|
| 808. | Cup knives 1435 slide against cup column 1405, securing column |
| | 1405, except for last cup 70, by their rims 1407 |
| 809. | Cup holding plate 1420 moves to wide portion 1427 position, |
| | releasing bottom cup 70 |
| 810. | Cup 70 slides down chute 1437 and through cup guidance cone |
| | 1439 into cup grip 710 of cup transport arm 700 |
| 811. | Cup holding plate 1420 moves to thin portion 1429 position, |
| | securing remaining cups in column |
| 812. | Cup knives 1435 pull back to base position, off from cup column |
| | 1405, allowing cup column 1405 to engage thin portion 1429 of |
| | hole 1425; i.e., Reset |

It will be appreciated that the above descriptions are intended only to serve as examples, and that many other embodiments are possible within the scope of the present invention as defined in the appended claims.

What is claimed is:

1. A method for delivering portions of hot liquid on demand comprising the steps of:
(a) providing a heating arrangement including:
(i) a thermal conduction block, and
(ii) at least one passageway through said block at least partially defining an elongated flow path from a heating arrangement inlet to a heating arrangement outlet, said elongated flow path having a volume V0;
(b) preheating the thermal conduction block together with the liquid in the elongated flow path to a raised temperature T0;
(c) receiving a request for dispensing a volume V of liquid at a temperature T;
(d) calculating a dispensing program including actuation of a heating element to supply heat energy to the liquid in coordination with allowing liquid flow through said elongated flow path, calculation of said dispensing program being based at least in part on parameters V, T, V0, T0 and an input temperature of the liquid; and
(e) dispensing the portion of liquid through the outlet by actuating the heating element and allowing liquid flow through said elongated flow path according to said dispensing program.

2. The method of claim 1, wherein said dispensing program is adjusted during said dispensing of the liquid based upon measurement of a rate of liquid flow through said heating arrangement.

3. The method of claim 1, wherein said input temperature of the liquid is measured by a temperature sensor.

4. The method of claim 1, wherein said dispensing program is adjusted based upon measurement of the input temperature of the liquid supplied to said inlet as measured during said dispensing.

5. The method of claim 1, wherein said calculation of the dispensing program and said dispensing are calculated and dispensed, respectively, with supply of heat energy by the heating element to the thermal conduction block.

6. The method of claim 5, wherein said dispensing program is implemented such that:
(a) during a first period, a temperature of said thermal conduction block is adjusted from temperature T0 to within a given margin of the required temperature T; and
(b) during a second period, said heating element is actuated as a function of a rate of flow of liquid through said elongated passageway to minimize temperature variations in said thermal conduction block while the liquid flows through said elongated passageway.

7. The method of claim 6, wherein adjusting the temperature of said thermal conduction block is performed by actuating said heating element prior to allowing flow of liquid through said elongated passageway.

8. The method of claim 6, wherein adjusting the temperature of said thermal conduction block is performed by allowing flow of liquid through said elongated passageway without actuating said heating element.

9. The method of claim 1, wherein steps (c), (d) and (e) are repeated to dispense a plurality of portions of heated liquid, and wherein step (d) is performed each time using a new value of T0 measured prior to said calculating.

10. The method of claim 9, wherein said plurality of requests define a plurality of differing respective temperatures T for the portions of liquid requested.

11. The method of claim 10, wherein said differing temperatures span a range of at least about 15 degrees Celsius, and wherein said preheating is performed to maintain said thermal conduction block at a standby temperature within about 10 degrees below a lower end of said range when no request is received for a given period.

12. The method of claim 9, wherein said plurality of requests define a plurality of differing respective volumes V for the portions of liquid requested.

13. The method of claim 1, wherein the liquid is water, and wherein the method is performed by an automated beverage machine.

14. A heater for delivering portions of hot liquid on demand comprising:
(a) a heating arrangement including:
(i) a thermal conduction block,
(ii) at least one passageway through said block at least partially defining an elongated flow path from a heating arrangement inlet to a heating arrangement outlet, said elongated flow path having a volume V0, and
(iii) a heating element deployed so as to deliver heat energy to said block;
(b) a first temperature sensor deployed to indicate a temperature of liquid within said elongated passageway;
(c) a valve deployed to selectively allow flow of liquid through said heating arrangement; and
(d) a controller including at least one processor, said controller being connected to receive signals from at least said first temperature sensor and to selectively actuate said valve and said heating element, wherein said controller is configured to:
(i) actuate said heating element to ensure preheating of said thermal conduction block together with the liquid in the elongated flow path to a raised temperature T0;
(ii) receive a request for dispensing a volume V of liquid at a temperature T;
(iii) calculate a dispensing program including actuation of said heating element to supply heat energy to the liquid in coordination with allowing liquid flow through said elongated flow path, calculation of said dispensing program being based at least in part on parameters V, T, V0, T0 and an input temperature of the liquid; and
(iv) dispense the portion of liquid through the outlet by actuating said heating element and said valve according to said dispensing program.

15. The heater of claim 14, further comprising a second temperature sensor deployed to indicate a temperature of liquid supplied to said inlet, thereby providing to said controller the input temperature of the liquid.

16. The heater of claim 15, wherein said controller is further configured to vary said dispensing program during flow of the liquid based upon said signal from said second temperature sensor.

17. The heater of claim 14, further comprising a flow sensor deployed to measure a rate of liquid flow through said elongated passageway. 51

18. The heater of claim 17, wherein said controller is further configured to vary said dispensing program during flow of the liquid based upon said signal from said flow sensor.

19. The heater of claim 17, wherein said controller is further configured to:
(a) during a first period, adjust a temperature of said thermal conduction block from an initial temperature to within a given margin of the required temperature T; and
(b) during a second period, actuate said heating element as a function of a rate of flow of liquid through said elongated passageway to minimize temperature variations in said thermal conduction block while the liquid flows through said elongated passageway.

20. The heater of claim 19, wherein said controller actuates said heating element prior to opening said valve so as to adjust the temperature of said thermal conduction block upwards.

21. The heater of claim 19, wherein said controller opens said valve prior to actuating said heating element so as to adjust the temperature of said thermal conduction block downwards.

22. The heater of claim 14, wherein said heating arrangement together with the quantity of the liquid contained within said elongated passageway has a total heat capacity not exceeding 1 kJ/K, and wherein a majority of said heat capacity is in said block.

23. The heater of claim 14, wherein said thermal conduction block is implemented as a block of substantially constant cross-sectional form, and wherein a pair of end covers define connecting passageways between portions of said elongated flow path. 52

24. The heater of claim 14, further comprising a scale reduction arrangement including a magnetic scale inhibitor and a circulator arrangement deployed to selectively circulate liquid through said elongated passageway and said magnetic scale inhibitor.

25-55. (canceled)
